(19) United States
(12) Patent Application Publication
(10) Pub. No.: US 2024/0423416 A1
(43) Pub. Date: Dec. 26, 2024

(54) MULTI-PURPOSE SMOKING ACCESSORY DEVICE WITH AUDIO SOUND SYSTEM

(71) Applicant: Alston Pough, New York, NY (US)

(72) Inventor: Alston Pough, New York, NY (US)

(21) Appl. No.: 18/700,438

(22) PCT Filed: Oct. 11, 2022
(86) PCT No.: PCT/US2022/046298

§ 371 Date: Apr. 11, 2024

Related U.S. Application Data
(60) Provisional application No. 63/254,392, filed on Oct. 11, 2021.

(51) Int. Cl. A47J 42/26; A24B 7/04; A47J 42/42; A47J 42/44

(52) U.S. Cl. CPC A47J 42/26; A24B 7/04; A47J 42/42; A47J 42/44

(57) ABSTRACT

The present disclosure is directed to a multi-purpose, smoking accessory device for tobacco, herbs, Cannabis and other smokable substances. The accessory device comprises several, convenient smoking related features presented in a single, compact unit. Such features, include (i) an air-tight storage component comprising multiple individual air-tight storage compartments for storing multiple types of non-ground smokable substances; (ii) a grinder for grinding specified amounts of said non-ground substances directly from the storage compartment(s); (iii) collection unit(s) for storing ground substances directly from the grinder; (iv) dispensing port(s) for receiving ground substances directly from the collection unit(s) and from which specified amounts of said ground substances may be dispensed; and (v) an audio sound system, together with several other convenient, electronic features, to enhance the user's smoking experience. The aforementioned smoking related features may be fully automated, semi-automated or manually controlled. Also, each such feature may be removably attached and transportable to accommodate the user's needs.

### A. FIELD OF THE INVENTION

The field of invention is generally directed to an accessory for smoking tobacco, herbs, Cannabis and other smokable substances, wherein the accessory comprises various components to facilitate, automate and/or enhance the user's smoking experience.

### B. DESCRIPTION OF RELATED ART

Smokable substances for use with the present invention include, but are not limited to, tobacco, herbs, and Cannabis. Cannabis can be smoked for medicinal or personal purposes in those areas in the U.S. where it is permissible under local and/or State law. Of particular note, more and more States in the U.S. are legalizing the personal use of Cannabis. This in turn has created a demand for additional smoking-related accessories to further facilitate, automate and/or enhance the smoker's experience such that it is, for example, more efficient, convenient and/or enjoyable.

Smoking Cannabis for medical purposes is reported to produce several well-documented beneficial effects, such as ameliorating nausea and vomiting, stimulating hunger in cancer patients undergoing chemotherapy or radiation. It has also been reported that smoking Cannabis provides beneficial effects to AIDS patients, lowering intraocular eye pressure resulting from Glaucoma, treating gastrointestinal illnesses, producing an analgesic effect, among other medicinal uses.

Usually, consumers store their smokable substances in a leather pouch, plastic baggy, case or a separate, albeit temporary storage container, which has can result in unnecessary spillage, misplacement, and odor. Also, conventional storage means can result in the smokable substance becoming stale over time. Moreover, many smokers use various types of containers with air-tight lids or screw tops (e.g., Mason jar) to store and preserve their smokable substances. However, these smokers often experience much inconvenience with these conventional items due to their lack of sufficient space and/or convenient means to store one or more types of smokable substances, and at the same time, sufficiently preserve the substance(s) freshness, as well as the ability to grind the smokable substance(s), play music, and recharge a cell phone, among other activities.

Moreover, certain components that can be used in connection with smoking, are stand-alone separate items. This results in much inefficiency, frustration and inconvenience among smokers, particularly avid smokers, because they need to store and maintain each of these items, among others, in the same place for easy access, which can be very difficult and very cumbersome. Also, not having these various items in the same place or part of a single, consolidated unit can cause the users' environment to appear sloppy and disorganized, making their smoking experience a hassle, unpleasant or otherwise much less enjoyable. The separateness of items that can be used in connection with smoking can also cause these items to easily get misplaced, as well as make travelling with each of these items very difficult. Despite these drawbacks, among others, consumers continue to partake in smoking for various reasons.

Many in the smoking accessory field have strived to make the smoking experience as simple, convenient, efficient and enjoyable as possible. However, there exists no single or consolidated device(s) that solve the above-mentioned problems. These problems can become more pronounced when smoking among a group of friends and acquaintances. Many users of medicinal and personal smokable substances enjoy listening to music while they smoke. This requires at least one individual in the group to have a readily accessible or portable audio sound system, which is not always the case, particularly when smoking outdoors or when some or all members of the group have to travel to a specified destination.

### C. NON-LIMITING OBJECTIVES OF THE INVENTION

One objective of the present invention is to provide an all-in-one device where various aspects of the smoking experience are automated. Such device comprising multiple components, including but not limited to: (i) storing the smokable substance; (ii) grinding the smokable substance so it can be easily smoked; (iii) storing and dispensing the ground smokable substance; and (iv) provide a means of entertainment, among other convenient features.

Another objective of the present invention is to prevent misplacement of smoking-related components, including, but not limited to, grinders, storage containers, dispensing units and other items commonly used in connection with smoking.

Yet another objective of the present invention is to provide convenience and efficiency for the medicinal or personal use of tobacco, herbs, cannabis, and other smokable substances.

Another objective of the present invention is to provide immediate and easy access to an audio sound system for playing music while smoking.

Yet another objective of the present invention is to improve and/or enhance the individual's smoking experience by automating various aspects necessary to process non-ground smokable substances.

Another objective of the present invention is to foster a hospitable environment among fellow smokers of medicinal or personal smokable substances, while the present invention serves as the center point for everyone to enjoy themselves as a cohesive unit while smoking together (e.g., listening to music together).

These and other non-limiting objectives of the present invention will become apparent from the figures herein, detailed description of the present invention, along with the other disclosures made herein.

In one embodiment, an apparatus is for processing dry materials and includes an enclosure defining an interior cavity divided into sections by walls that define interior regions comprising a grinding section, a dispensing section, and an electronics section. A grinder assembly fits within the grinding section and is configured to receive dry materials for grinding. A dispensing section with a drawer receives ground materials from the grinder assembly. An electronic control system fits within the electronics section. An insulator layer connected to at least the walls defining the electronics section separates the electronics section from the grinder assembly and the dispensing section.

The grinder assembly may include a motor controlled by the electronic control system. The grinder assembly may include grinding elements connected to a respective top section and bottom section of the grinder assembly.

The top section and the bottom section of the grinder assembly are configured to join together and define an area for receiving the ground material.

The area for receiving the ground material may be surrounded by portions of the grinder assembly defining a holding container for the ground material.

The grinder assembly may include a screen between the grinding elements and the holding container, wherein the screen allows select particles of the ground material to enter the holding container.

The drawer of the dispensing section receives the ground material from the screen.

The insulator layer may include shock absorbing materials to separate vibrational energy from the grinding section from the electronics section.

The insulator layer may include a polymer, a rubber, a nylon, or a plastic.

The electronics section may include a computer storing a control system that operates a motor connected to the grinder assembly.

The electronics section may include a computer storing a control system that operates an entertainment system comprising speakers.

The electronics section may include a power supply connected to the computer and the motor.

The electronics section may include a computer configured to receive electrical inputs from ports built into the enclosure.

The electronic control system and the grinding assembly operate simultaneously while separated from each other by the insulator layer.

The drawer is removable from the dispensing section.

The dry material and the ground material may be a smokable material or an ingestible material as described herein.

### D. BRIEF DESCRIPTION OF THE DRAWING(S)

Having thus described the invention in general terms, reference will now be made to the accompanying figures, which are not necessarily drawn to scale, and which illustrate, by way of non-limiting examples, the constituents of the present invention.

FIG. 1 is a schematic illustration of an apparatus according to this disclosure.

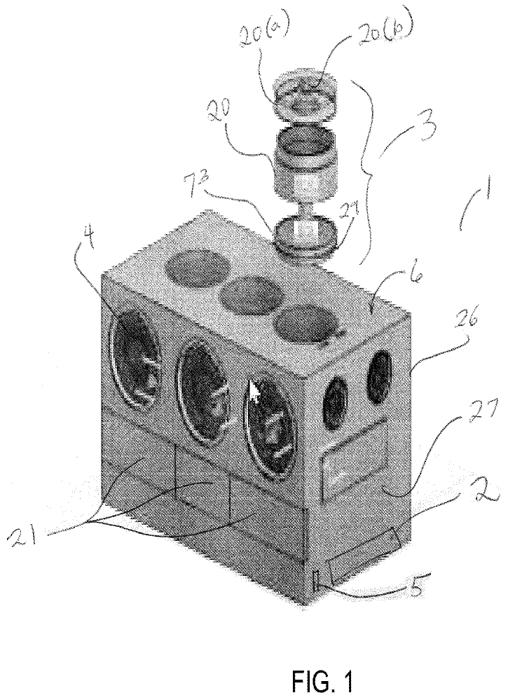

FIG. 2 is a schematic illustration of an apparatus according to this disclosure.

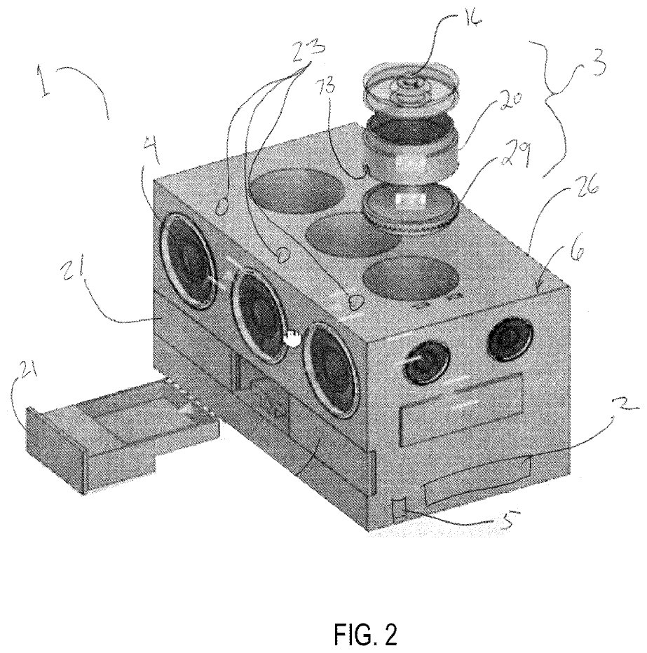

FIG. 3 is a schematic illustration of an apparatus according to this disclosure.

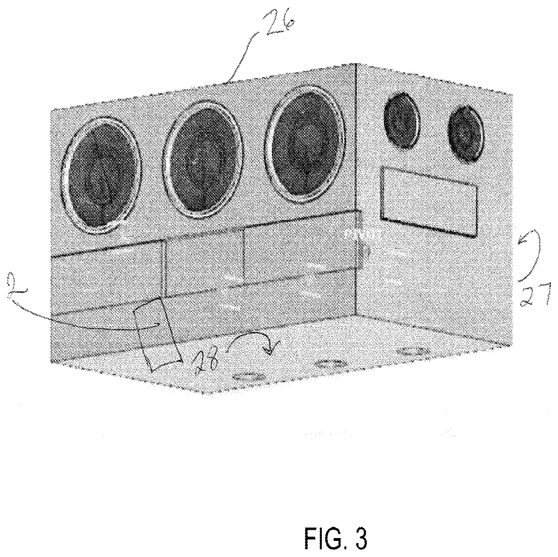

FIG. 4 is a schematic illustration of an apparatus according to this disclosure.

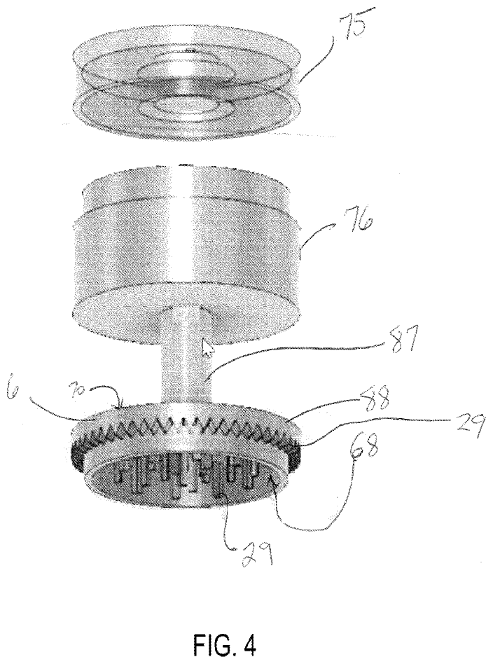

FIG. 5 is a schematic illustration of an apparatus according to this disclosure.

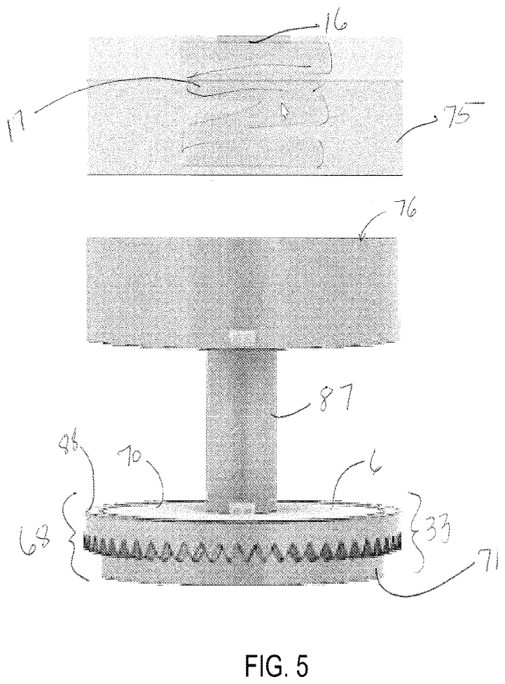

FIG. 6 is a schematic illustration of an apparatus according to this disclosure.

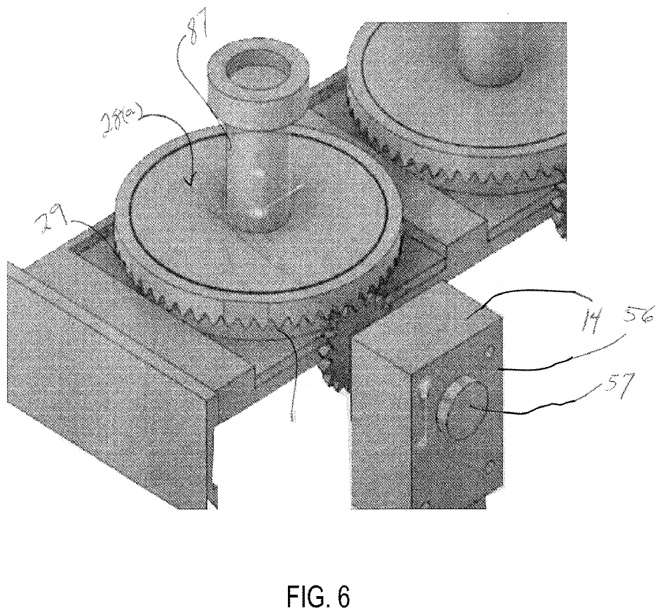

FIG. 7 is a schematic illustration of an apparatus according to this disclosure.

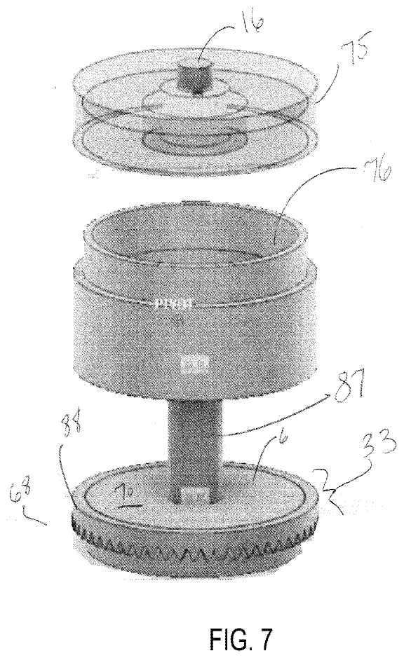

FIG. 8 is a schematic illustration of an apparatus according to this disclosure.

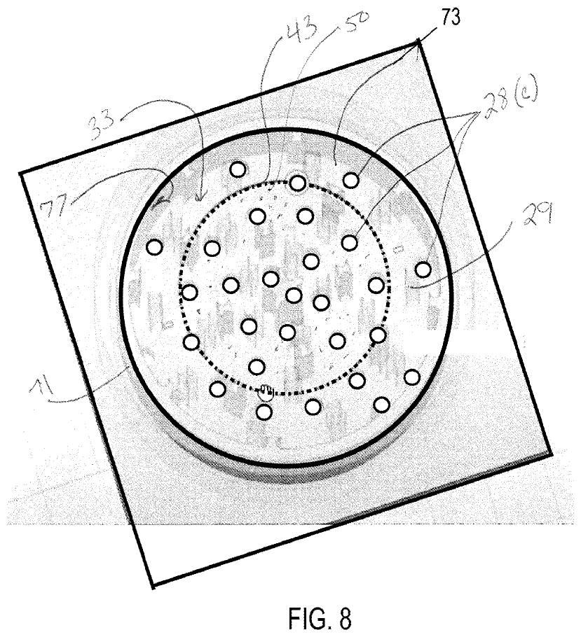

FIG. 9 is a schematic illustration of an apparatus according to this disclosure.

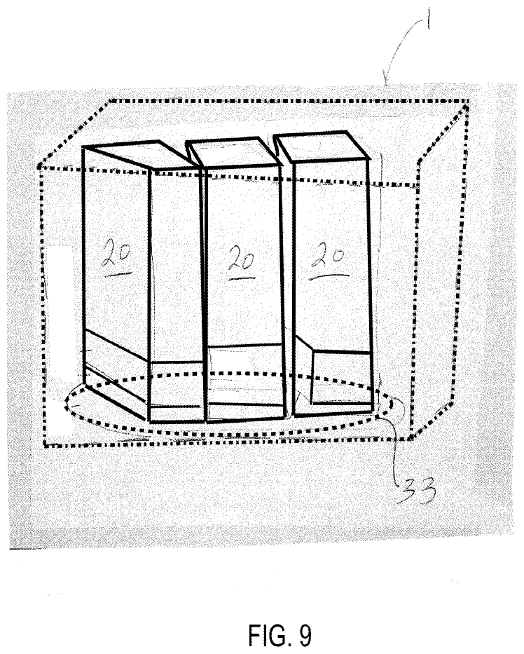

### E. DETAILED DESCRIPTION OF THE INVENTION AND EXAMPLES

Provided below is a more detailed description of the present invention with reference to the accompanying figures, in which some, but not all embodiments of the present invention are shown. Any specific, non-disclosed embodiments would, however, be readily apparent to one skilled in the art as falling within the scope of the present invention based on the disclosures herein. Indeed, for this reason, among others, one skilled in the art would understand that the present invention can be embodied in other forms. Thus, the scope of the present invention is not and should not be construed as limited to the embodiments and disclosures set forth herein and in the figures. In regard to the figures, like numbers refer to like elements throughout.

The present invention overcomes the above-mentioned problems, among others, by providing an all-in-one smoking accessory device having, for example, a grinder, one or more storage containers (preferably an airtight or sealed container), USB port, and an audio sound system for playing music, among other components.

While the present invention is described as a device for processing smokable substances, it is not limited to only these types of substances. Any plant, spice, tobacco, medicinal compound, or any other organic material that is maintained when stored in an airtight container, and requires grinding, may be stored in the present inventions collection unit.

### 1. Smokable Substance

The term “smokable substance” includes, but is not limited to, tobacco, Cannabis Herbs, or any other herbal or herbal-like substance, resin or raw plant material which can be smoked, inhaled, made into a drink, or even chewed or eaten for medicinal, recreational or personal purposes. The word “Cannabis” includes, but is not limited to, dried leaves, flowers, stems, and seeds from the Cannabis plant. Cannabis is a species of flowering herb, which includes marijuana, which is further split into at least three subspecies or strains: (i) indica, (ii) sativa, and (iii) ruderalis. In some non-limiting embodiments, the strains for the present invention are indica and sativa. Cannabis, as used herein, includes any medicinal and recreational marijuana, and resins derived from Cannabis, such as hashish.

The smoking accessory device of the present invention may be constructed in various shapes, dimensions and sizes. For instance, the device may form a generally rectangular box-like shape or cylindrical shape. In other embodiments, the smoking accessory device may have myriad shapes and dimensions, including, without limitation, a rectangular tube shape, an elongated triangle shape, a cubical shape, and a spherical shape. Moreover, the present invention comprises the novel feature of having each component removably attached to each other, producing a myriad of advantages to the user.

### 2. Internal Rechargeable Battery and Power Source for the Smoking Accessory

In one alternative embodiment, the smoking accessory device of the present invention 1 may comprise an internal rechargeable battery 2 to operate a grinder 3, audio sound system 4, or any other constituent of the present invention requiring an electric current to operate. The present invention may also comprise a removable collection unit for storing the ground smokable substance. The internal rechargeable battery 2 may be recharged via a plug 5, which can be situated almost anywhere on the external surface 6 of the smoking accessory device 1. The power for the rechargeable battery 2 can come from numerous power sources, including, but not limited to, a computer laptop, an electrical outlet or receptacle, power outlet or adapter in an automobile (e.g., cigarette lighter), or mobile generator having an electrical outlet or receptacle thereon or connected therewith. An electrical outlet or receptacle may include, for example, a convention electric socket that connects an electrical device to a source of electricity.

Electrical power may be provided to the internal rechargeable battery 2 via an electrical charging system, including but not limited to, a USB (Universal Serial Bus) connection system. A USB connection system 10 may include, but are not limited to, USB 1.x, USB 2.0, USB 3.x, USB 4, USBC, among other computer bus and power connector assemblies, such as Lightning™ created by Apple Inc. USB is just one example of an electrical connection system suitable for the present invention. One skilled in the art would understand that there are several types of connection systems capable of conducting electricity to the smoking accessory device of the present invention from an external electrical power source 7 to recharge the internal rechargeable battery 2. The present disclosure includes devices that may also be powered directly via plugging in an electrical plug 7a in an electrical power source, for example, an electrical outlet 7b where no internal rechargeable battery is required.

Also, the present disclosure includes one or more charging ports for recharging the internal rechargeable battery 2, and such ports can be located on the external surface 6 of the smoking accessory device 1, where a charging plug 8 on one end of a USB connector is inserted into the charging port 9, and the other end of the charging plug 8 has a USB connection system 10, and said system is inserted into a suitable power source 11 having a compatible USB port 12. The preferred power is any form of electricity.

These constituents can be powered directly from the rechargeable battery 2 or directly from plugging in electrical plug 7a into an electrical outlet 7b. In another alternative embodiment, primary batteries can serve as the power source to operate the smoking accessory device of the present invention

In yet another alternative embodiment, the rechargeable battery 2 can power, for example, a DC motor 14 which in turn may be activated by turning on one or more power switches 15. For example, the DC motor 14 can provide the necessary power to operate the grinder 3, audio sound system 4 or any other electrical constituent of the present invention. These components can be powered directly from the rechargeable battery 2 or directly from plugging in electrical plug 7a into an electrical outlet 7b. In another alternative embodiment, primary batteries can serve as the power source to operate the smoking accessory device of the present invention. Further, operation of the smoking accessory device can be carried out by, for example, pushing one or more buttons 16 located on the external surface 6 of the smoking accessory device 1. Also, the USB connection system 10 may also provide power to the smoking accessory device 1. For example, a USB connection system 10 suitable for use in the smoking accessory device 1 of the present invention can provide at least a 5 V supply on a single connector from which the connected USB connection system 10 may draw power. It will be understood that other portable sources of power can be utilized as well. Further, the power source for the smoking accessory device 1 may comprise a conventional electric plug (male connector) 7a, with protruding pins that match the openings of a conventional electric socket; where the plug is inserted into the socket to obtain the necessary electric current to operate one or more components of the smoking accessory device that require a power source, including electricity, to operate.

In yet another alternative embodiment, the smoking accessory device 1 of the present invention can include a light 17 generated, for example, by a light-emitting diode (LED). The light 17 can indicate the current power remaining in the rechargeable battery 2 by lighting up, for example, in green (when sufficient power is present) and in red (when charging is required). The light 17 can be activated by triggering a push button switch 18. The light 17 can specify the amount of power remaining in the internal rechargeable battery 2 with one or more colors according to predetermined power thresholds in the internal rechargeable battery 2. The device of the present invention may also comprise a reset switch 19 which can function as a kill switch. The reset switch 19 may also be used to reset the device and/or restart it.

In another embodiment, the smoking accessory device may include a retractable power cord 7a assembly configured to selectively extend and retract and may be defaulted to a retract state via springs or other conventional means known in the art.

### 3. Storage Component for Non-Ground Material

The smoking accessory device 1 of the present invention may comprise at least one storage component 20 for non-ground smokable substances. In one preferred embodiment, the at least one or more storage components 20 may maintain at least a sufficiently airtight seal or lid 20a to keep the smokable substance moist and fresh for a sufficient amount of time, preferably for at least two weeks or more. In a more preferred embodiment, the storage component 20 is virtually airtight or completely airtight. Lid 20a may comprise of a handle 20b as a means for lifting lid 20a to provide access to/or add smokable substance in the one or more storage components 20. The storage component can be made of various materials, including, but not limited to, various grades of plastic, rigid polymers, metal (e.g., aluminum), glass, ceramic, wood, and carbon fiber.

In one preferred embodiment, each of the one or more storage components 20 may comprise multiple, separate compartments 21 therein for storing various types of smokable substances. Each compartment 21 may be labeled to specify the particular smokable substance inside a particular compartment 21. In yet another preferred embodiment, the user can choose which smokable substance in the one or more compartments 21 the user wants to grind using grinder 3 and then smoke or store the ground material for later use in a collection unit 73. This feature is particularly useful for smokers using various strains, grades or types of smokable substances offered in the market. In one preferred embodiment, the smoking device may comprise 1-10 storage compartments 21 for storing multiple types of non-ground smokable substance, preferably 1-5 compartments, more preferably 1-3 compartments.

4. Electronically or Manually Selecting a Particular Smokable Substance from the One or More, Individual Storage Compartments

As mentioned, the present invention may comprise storage component 20, which may further comprise separate, multiple compartments 21 for storing various types of non-ground smokable substances, whereby no mixing of said substances occurs, unless the user wishes to mix them. Choosing which smokable substance to grind and smoke from among the others substances can be a conveniently automated process under the present invention, where the user can electronically and/or remotely select a specific amount of a particular non-ground smokable substance from among the many individually stored non-ground substances in compartments 21 for grinding. The specified amount may be controlled by stopping the motor by depressing or releasing the button or the on/off may be controlled remotely via mobile device communicatively coupled with the devices disclosed along with a hand-held remote control.

In a semi-automated embodiment, lever 22 may be positioned on the exterior surface 6 of the smoking accessory device 1. The lever 22 is communicatively engaged with each individual storage compartment 21 such that when the lever 22 is manually actuated, it can cause each compartment 21 to move from one position to another in the storage component 20. Continued actuation of lever 22 enables the user to select a particular, non-ground smokable substance among the one or more compartments 21 containing different types of non-ground substances, and where such actuation also enables the user to position the selected compartment 21 above and communicatively engaged with grinder 3, where a specified amount of the smokable substance inside that compartment 21 can then be released into grinder 3 for grinding, either electronically or manually.

Once grinding is completed and the ground substance is released into collection unit 73, then the user may release a specified amount of the ground substance into a dispensing port by depressing the appropriate button for a particular amount of time. The amount of ground substance to be released from collection unit 73 into dispensing unit is proportional to the length of time button is depressed. In one embodiment, the user can visualize the amount of smokable substance being released from the grinder into the collection unit 73 while continuing to depress button. The release of said ground substance from the collection stops automatically once button is no longer depressed or said button is placed in the off position.

The amount of the selected ground substance to be released from grinder 3 into collection unit 73 can be effectuated manually by pulling lever outward long enough until the desired amount is released from compartment 21. In one embodiment, the user can see the amount of smokable substance being released from the grinder while lever remains in the outward position. The released amount of ground substance from compartment 21 that the user can visualize is proportional to the length of time the lever is pulled. Indicator 23 may also be communicatively and/or electronically coupled to each storage compartment 21, such that when one compartment is moved from one position to another either electronically, or manually by actuating level 22, a number or other indicia will be displayed in indicator 23 or on the touch bar display 24, thus enabling the user to know with certainty that the smokable substance in the selected storage compartment 21 is above and communicatively engaged with grinder 3.

In another embodiment, the user can manually move (e.g., rotate) the storage component 20, thus allowing the user to choose and position a particular compartment 21 within the storage component 20 to be communicatively engaged with a grinder 3 so that the chosen smokable substance inside that compartment is dispensed in the grinder for grinding. In another embodiment, the individual compartments 21 can be removed from its current position and reinserted in a position whereby the compartment 21 of interest is communicatively engaged with the grinder 3 so that the smokable substance inside that compartment 21 is dispensed in the grinder 3 for grinding. In another embodiment, to avoid unintended mixing of the various smokable substances, only one compartment 21 within the storage container 20 can be communicatively engaged with a grinder 3 at a time. Stated another way, each compartment 21 of the stored non-ground smokable substance is engaged with grinder 3 and is completely separate and independent of the other compartments 21 containing different strains of smokable substances, so no mixing.

In a further embodiment, lever 22 may be electronically and communicatively coupled to both the storage component 20 and indicator 23 or touch bar 21. When the lever 22 is actuated, the indicator 23 or touch bar 24 will reveal to the user via a display at least one of a series of numbers, letters or any other indicia informing the user which particular storage compartment 21 is already being communicatively coupled with grinder 3. Thus, actuation of lever 22 enables the user to communicatively couple a particular compartment 21 to grinder 3 such that the smokable substance therein is dispensed for grinding. The indicator 23 or touch bar 24 can also inform the user which compartment is already communicatively coupled to a grinder 3 before actuating the lever 22. In yet another embodiment, the one or more compartments 21 can be selectively removed manually and repositioned inside the storage component 20 such that the selected compartment 21 is communicatively coupled to the grinder 3. In another embodiment, any one of the separate compartments 21 can be communicatively joined to each other, allowing them to be manually rotated together by the user so that the desired compartment can be communicatively coupled to grinder 3 wherein the smokable substance therein can then be dispensed in grinder 3 for grinding.

In another automated embodiment, the multiple, separate compartments 21 can be electronically repositioned (e.g., rotated) inside the storage component 20, thus allowing the user to communicatively couple a particular compartment 21 to a grinder 3 so that the smokable substance therein is dispensed in the grinder 3 for grinding. In yet another alternative embodiment, the separate compartments 21 can be communicatively joined to each other. The communicatively joined compartments can then be coupled to a motor 14, preferably a DC motor, and the motor 14 can be coupled to an internal rechargeable battery 2 which serves as a power source for the motor 14. When the motor 14 is powered by battery 2, for example, the motor 14 actuates the communicatively joined compartments 21 in a manner (e.g., rotatably) allowing the user to select which particular compartment 21 will be communicatively coupled to grinder 3 where the smokable substance therein is dispensed in the grinder 3 for grinding. In another preferred embodiment, the present invention may further comprise an indicator 23, for example, in the form of an LED display 74 indicating by number, letter or any other indicia identifying which particular compartment 21 is already communicatively coupled to grinder 3 for grinding the contents therein, whereby the user, if he/she so desires, may electronically or manually reposition the one or more storage compartments 21 so that the desired compartment therein can be repositioned by the user so that said compartment 21 is electronically and communicatively coupled to grinder 3 for grinding the contents therein, and indicator 23 will display 74 that said compartment is properly positioned for grinding its contents.

### 5. Grinder

The grinder 3 for use in the present invention is capable of grinding the smokable substances described herein to a desired fineness or at least sufficiently ground so the smokeable substance can be smoked by an individual using, for example, a pipe, rolling papers, vaporizer, bowl piece or other items used for smoking.

i. Grinder Housing

In one preferred embodiment, the grinder 3 may comprise a housing 26, where said housing may further comprises an exterior 27 and interior 28.

ii. Shape, Function and Constituents of Grinding Elements

The interior of the grinder's housing 28 may comprise one or more grinding elements 29. The one or more grinding elements 29 are adequately shaped or configured to shred/chop and/or grind the smokable substance to a desired level of fineness, or at least sufficiently ground so it can be smoked or otherwise ingested. The one or more grinding elements 29 may take various shapes and forms. For example, the grinding elements 29 can be elongated, non-elongated, compact, stout, non-linear, diminutive, or truncated. At least one surface on which grinding elements 29 are placed may also comprise teeth, a tooth, or one or more protuberances, raised edges, pegs, projections, spikes, pyramids with pointed tips, or raised rectangles, squares, circles, ovals, and other polygonal shapes in aligned or staggered arrangements. In one embodiment, the grinding elements 29 are removable and interchangeable. Also, at least one surface on which the grinding elements 29 are placed can have one or more formations thereon sufficient to ground the smokable substance to a desired level, where each such formation can be sharp, serrated, toothed, notched, ridged, saw-toothed, striated, nicked, angular, bent, crooked, pitted, jagged, or zigzagged. The one or more grinding elements 29 may have different or the same pitches or angles suitable for grinding the smokable substance to a level where it can be smoked. Grinding elements 29 may have no pitch or angle at all. The one or more grinding elements 29 may also comprise one or more blades. Each blade may have single, dual, tri, or quad bladed tips.

The one or more grinding elements 29 may be made of any suitable material known in the art (e.g., metal, plastic, wood, ceramic, or various types of plastic polymers, preferably a rigid polymer.) used to chop, fragment, comminute, pulverize crush and/or shred the smokable substance when the one or more grinding elements are actuated by the motor coupled to the shaft.

By way of example, the grinder's interior 28 may comprise a top portion 28a and bottom portion 28b. Both the top and bottom portions, 28a and 28b respectively, may comprise one or more grinding elements 29, whereby the grinding elements 29 on the top portion 28a are complementary or otherwise compatible with grinding elements 29 on the bottom portion 28b. Preferably, said top portion 28a and bottom portion 28b may also comprise one or more apertures 28c to allow the ground material to pass through and collect inside holding container 68 while the smokable substance is being ground or afterwards. Preferably, bottom portion 28a comprises one or more apertures 28c to allow the ground material to pass through and collect in holding container 36, where said holding container 68 is positioned underneath the bottom portion 28a of the grinder's interior housing. The grinding elements 29 are actuated to ground the smokable substance to the users desired fineness via a motor powered by internal rechargeable battery 2 or from any another source of electricity.

Apertures 28c may comprise any shape, form or configuration, but the overall size of the aperture must be suitable for holding the non-ground smokable substance in place for grinding. Preferably, the sizes of the apertures are such that at least the majority of the smokable substance will not pass through the grinder into holding container 36 before said substance is ground by grinder 3.

Grinder 3 may come in a variety of configurations. For example, grinder 3 may comprise a 2-part grinding mechanism having a top part 75 and a bottom part 76, both parts have two or more sides 77, with at least one side having one or more grinding elements 29 on at least one side 77 of the top part 75 and bottom part 76 to shred the smokable substance when the grinding elements 29 on the side of said top 75 and bottom 47 are caused to cooperatively engage with each other in a manner to cause shredding, chopping and/or grinding of the smokable substance, at which point the ground substance may be dispensed for use or storage un the collection unit 73.

In another non-limiting embodiment, the interior of the grinder's housing 28 may comprise a lighting member 30 to provide, for example, illumination. Such illumination may provide, for example, the user more visibility to monitor the grinding process or to monitor the fineness of the smokable substance as it is being ground. Lighting member 30 can be positioned, for example, above the top portion 28a or bottom portion 28b (not shown) of the grinder's interior housing 28.

Lighting member 30 may also be positioned on the external surface 6 of the grinding unit 3 or anywhere in the grinder's housing 26. Preferably, lighting member 30 may be positioned along the top portion 28a of the interior 28, or on or underneath the bottom portion 28b of the grinder's interior 28 to sufficiently illuminate the ground smokable substance before, during and after grinding. Lighting member 30 may also be positioned underneath the bottom portion 28b of the grinder's interior 28 or the top potion of the collecting plate 32 so that it can illuminate the interior of said collecting plate 32 for the kief coming from the grinding of the non-ground smokable substance. In yet another preferred embodiment, one or more lighting members may be installed anywhere inside or on the outer surface of grinder 3 for decorative or any other relevant functional purpose.

In another alternative embodiments, at least a sufficient portion of the external surface of grinder 3 is made of a material that enables a user to see the extent to which the smokable substance is being ground by grinder 3 during and after the grinding process. Such material may include, but are not limited to, a clear, translucent, transparent, or semi-transparent plastic or metallic material. In another embodiment, the entire surface of grinder 3 is made of a clear, translucent, transparent, or semi-transparent plastic or metallic material providing an illuminated or non-illuminated view into collection unit 73 as the smokable substance is being ground.

The grinder 3 of the smoking accessory device 1 can further comprise a drive shaft 87 mounted and received in the grinder's chamber 88 through an aperture 89 in the spacer 90. When activated, the driver shaft 87 rotates, which in turn rotates the one or more blades or knives attached to said shaft, which then grinds the smokable substance.

### VI. Collection Unit for Ground Smokable Substance

The smoking accessory device of the present invention may comprise a collection unit 73, which further comprises a holding container 36 to collect the ground smokable substance before during and/or after the grinding process. It also may comprise a collecting plate 32 for the kief. Collection unit 73 may further comprise a top portion 72 and bottom portion 69. Also, the collection plate 32 may comprise one or more side walls, thus forming an enclosure where the kief can accumulate from grinding the smokable substance with grinder 3. Preferably, collection unit 73 is positioned underneath grinder 3 such that the grounded material passes through the apertures 28c into holding container 36, and the resulting kief passes through screen and accumulates in enclosure. Also, collection unit 73 may be used to store, preserve and/or to transport the ground smokable substance, as collection unit 73 may be preferably removably attached or otherwise linked to grinder 3, as discussed in more detail herein.

When detached from one embodiment of the smoking accessory device of the present invention, or any component thereof, collection unit 73 may comprise a standalone and transportable storage container for ground smokable substance. Specifically, when detached, the collection unit 73 may comprise a removably attached top lid 71 or bottom lid 70. The collection unit 73, along with top and bottom lids, 71 and 70, respectively, can be made of any materials suitable for storing ground organic matter, which include, but are not limited to, metal, glass, rubber, plastic, ceramic, or a rigid polymer.

Preferably, the top portion 72 or bottom portion 69 of collection unit 73 may be threaded along either their respective top or bottom ends. More preferably, the top and bottom ends and, respectively, of collection unit 73 may be threaded such that said threading can receive and securely mate with, for example, the threading along an inner side of either top or bottom lids, and respectively, which enables said lids to be securely fastened to collection unit 73 by rotating the threaded portions of said lids on said threaded portions of collection unit 73. More preferably, the top and bottom ends and, respectively of collection unit 73 are configured to receive the threaded portions of top or bottom lids, and, respectively, such that top lid 71 and bottom lid 70 can be removably fastened to the top portion 72 and/or bottom portion 69 of the collection unit 73, respectively, such that the collection unit 32 with ground smokable substance therein forms a suitable storage container for said smokable substance.

Other means may be used for fastening the top lid 71 or bottom lid 70 over the collection unit's top or bottom ends. Such other means may include, but are not limited to, a seal-cover lid. Said lids fit tightly and are spill resistant. They may comprise a base with a side wall surrounding said base. The lid's base may be flat and is may be shaped in the same configuration as the top or bottom end, and, respectively, of the collection unit 73. In this embodiment, the side walls fit sufficiently tight over the top or bottom end, and, respectively, of the collection unit 73 to keep the contents therein fresh until a user is ready to use said contents, The lid also keeps the ground smokable substance from falling out. More preferably, the lid's side wall may fit tightly along either the top or bottom end of collection unit 73 to form an airtight seal. The seal cover lid can be removed manually with light force.

Other types of container/lid assemblies not illustrated herein, and which may be used as the collection unit 33 of the present invention are known in the art. Such container/lid assemblies comprise containers having means for receiving lids at the containers upper or lower end. More preferably, such lids form an air-tight seal when securely fastened to the container's upper or lower end, respectively. Such lids may also comprise grippers along the sides or edges of the lid. Such lids may further comprise one or more hinged or movable flange on the side of the lid. Once said lid is fastened to the top or bottom end of the container, the flange may then be forced downward where it then grips in a snap-like fashion to an outer lip on either the top or bottom end of the container. Once the lid is snapped in place, the flange serves as a latch-type mechanism, which further secures the lid in place, preventing the airtight seal from being inadvertently broken. Simple Snap-On or cover lids may be also be suitable. Other types of container/lid assemblies included those used for mason jars, including lids comprising latch mechanism or screw tops. (e.g., Mason jar) to secure the lid in place.

In yet another non-limiting embodiment, the collection unit 73 may comprise an airtight seal by securely fastening either the top and/or bottom lids, 70 and 71, respectively, to the top or bottom portion of the collection unit 73, as the case may require. When either or both said lids are removably fastened to their respective top or bottom portions of the collection unit 73, a hermetic seal can be formed. The airtight seal facilitates preservation of the flavor and smell of the smokable substance by keeping it impervious to gases, and thus retaining the essence of the smokable substance within the collection unit 73. Further, in regard to securely fastening lids 70 and 71 on either the top or bottom portion of collection unit 73, any conventional mating or fastening mechanism known in the art may be used. In another embodiment, top lid 71 and bottom lid 70 may be securely fastened to the collection unit's 73 sidewalls and/or its top or bottom edges. For example, the top lid 71 and bottom lid 70 may be shaped in substantially the same form as the top and bottom edges, and, respectively of collection unit 73. In one embodiment, the detachment of lids 71 and 70 from collection unit 73 may involve a simple rotation and pulling action that may be performed manually.

Further, collection unit 73, which comprises holding container 36 and collecting tray 32 for the Kief may be positioned below the bottom 3 portion of the grinder's housing 28a or said tray 32 can be within the interior of the grinder's housing 28. The grinder 3 and collection tray 32 may be removably attached or fastened to each other to form a single unit.

### VII. Collecting Tray for the Kief

“Kief” refers to the super fine, powdery, dust-like substance obtained from ground smokable substances. Kief is also referred to as “pollen” because it looks like a fine coating of flower pollen. In a preferred embodiment, the bottom portion of the holding container 36 may comprise a tray to collect the Kief resulting from grinding the smokable substance. The tray may comprise a flat base and side walls around the base. For instance, screen can be positioned below grinder 3 to form a chamber, and the interstices and configuration of screen are sufficient to catch the finely ground smokable substance when ground by grinder 3 and then the ground material passes through apertures and into the holding container 36. Yet, the size of screen's interstices and their configurations are enough to allow the Kief to pass through and accumulate in the collecting tray.

In another preferred embodiment, screen may be securely fastened or otherwise positioned near or at the bottom portion or end of the holding container 36 using known means for in the art. In another alternative embodiment, 2 or 3 very fine opening sifting screens can be stacked together, creating a Kief chamber. In yet another embodiment, a collecting plate 43 for the Kief may be attached to the bottom portion or end of the grinder to allow the Kief to pass through said screen and into the collecting tray. The length of the side walls of the collecting tray may range from 0.1 cm to 10.0 cm, or more. In another preferred embodiment, the collecting tray for the Kief may comprise a screen securely positioned at the top end of the side walls of the collecting tray. The screen and side walls this form a chamber for the Keif to accumulate while the smoking substance is being ground.

Kief naturally measures about 75-125 microns. A non-limiting, preferred screen for use in the present invention should measure 100 to 270 lines per inch (LPI). Screen may also comprise multiple holes 50 sufficiently small in size so that the ground-up smokable substance is caught in the screen, yet the Keif can pass through said holes 50 and into the collecting tray 48 below.

The screens for use in the present invention may be securely fastened in the interior 28 of the holding container 36 via various means known in the art, including positioning the screen along a series of indents horizontally running along the side wall of said interior of holding container 36. Alternatively, the screen can be securely placed along a series of indents running horizontally along said side wall of the collecting tray. In another embodiment, the screen can be securely positioned by attaching it along one or more protruding lips along a side wall of the interior of the of the holding container 36. In a further embodiment, the screen can be securely placed or along a series of indents or one or more protruding lips along the side wall of the interior of the collecting tray.

The collecting tray may is removably attached to the collection unit to provide the user access to the accumulated Kief.

In one alternative embodiment, removal of the collecting plate can be achieved by sliding it outward from the bottom portion of the holding container 36.

The screens for use in the present invention may be removable and replaceable. This feature, among others, makes it easier to clean the screen or remove clogged screens from either the collecting tray or holding container 36. Further, the screens for use in the present invention may comprise any suitable material that permits the ground smokable substance to pass through the grinder 3 and into holding container 16 where it is held for storage, except that the interstices and/or configurations are sufficient to allow the kief to pass through and into the collecting tray. The screen may include, but is not limited to, a screen or mesh, or similar material having suitably sized interstices to enable the ground smokable substance to pass through. The filter component may be comprised of any suitable metallic material, including but not limited to, stainless steel, aluminum, copper, and brass. The filter component may also be comprised of plastic, nylon, ceramic, or various types of plastic polymers, preferably a rigid polymer.

### VIII Grinder Coupled to Motor and Power Source (Grinding)

Further, in one preferred embodiment, the one or more grinding elements 29 may be positioned on either an upper plate or bottom plate, or both. Each plate can be of any shape or thickness provided neither of these features interfere with the grinding element's 29 ability to ground smokable substances. Each plate comprises a top surface and bottom surface. Preferably, the one or more grinding elements are positioned on either the top surface of upper plate or bottom plate, or both. Preferably, the one or more grinding elements 29 are on the top surface of both the upper and bottom plates, such that plates and, respectively, with grinding elements 29 thereon are on opposite sides relative to each other. More preferably, the one or more grinding elements 29 on the top surface of the upper plate are above the one or more grinding elements 29 on the top surface of the bottom plate. Further, each plate can also be communicatively coupled to an electronic motor, preferably a DC motor 14. The motor 14, in turn, can be coupled to an internal rechargeable battery 2, which can serve as the motor's 14 power source. The grinding elements 29 may also be powered by other electrical sources, including power from a household electrical outlet, among other means.

In one embodiment, grinding of the smokable substance is activated by depressing button or touching the appropriate icon or indicia displayed on touch bar. This in turn activates motor 14, which is powered by, for example, internal rechargeable battery 2. Motor 14 then actuates the upper plate and bottom plate of grinder 3; each plate having one or more grinding elements 29 on their respective front surfaces and. Actuation of motor 14 causes each plate to move in a manner whereby the one or more grinding elements 29 on each plate and ground the smokable substance to a desired fineness or at least sufficiently ground to be smoked. In another alternative embodiment, when motor 14 is activated, it then can cause said upper and bottom plates and; each with one or more grinding elements 29 thereon, to move in a reciprocating manner, thus effectuating the grinding of the smokable substance dispensed in grinder 3.

An alternative electrical power source to activate the upper and bottom plates may include plugging an electrical cord from the smoking accessory device 1 into an electrical socket, where said electrical power source is coupled to motor 14, which is, in turn, electronically and communicatively coupled to the upper and bottom plates, and respectively, such that said plates can be activated to ground the smokable substance as described above by depressing button, which is communicatively coupled to motor 14. In another embodiment, releasing button will stop or pause the grinding.

In yet another embodiment, grinder 3 of the present invention may be transportable and functional as a stand-alone grinder, separate from the other components of the smoking accessory device. For example, grinder 3 may comprise both its own motor and internal rechargeable battery, preferably said motor and battery are securely positioned in the interior of grinder 3. Here, said motor may be electronically and communicatively coupled to the upper and bottom plates of grinder 3; the front surface of each plate and comprising one or more grinding elements 29, and motor is electronically and communicatively coupled to both said upper and bottom plates, along with being communicatively coupled with button on the exterior surface of the grinder, where depressing button causes the upper and bottom plates to engage in a repetitious, reciprocating motion relative to each other, as described herein, such that the plates' movement, with grinding elements 29 on each of the plate's front surface and, can grind the smokable substance to a desired fineness.

Such reciprocating movement includes, but is not limited to, said plates and effectuating the grinding process by spinning, twirling, gyrating, or rotating in opposite directions relative to each other. Said plates can also effectuate grinding of the smokable substance via reciprocating motion of said upper and bottom plates relative to each other; with each plate comprising one or more grinding elements 29 on the plates and respective front surfaces and, respectively. Such reciprocating motion of said plates and may include, but is not limited to, a repetitive up-and-down motion, side-to-side motion, or back-and-forth motion. Said motion of both plates being sufficient to cause the smokable substance to be ground to a desired fineness via crushing, chopping, dicing, cutting-up, or slicing, among other means of grinding, depending on the particular type, shape and configuration of the one or more grindings element being actuated at the time of grinding. The one or more grinding elements 29 can be affixed or removably affixed to each plate's and respective front surface by any suitable means known in the art, including, but not limited to, a screw, rivet, clasp, hook, or latch. Said grinding elements 29 can also be welded, soldered, glued, or otherwise rigidly affixed to the plates and front surface.

In one embodiment, the upper and bottom plates, and, respectively, comprising one or more grinding elements 29, may be communicatively coupled to each other via shaft. Moreover, the shaft, together with said upper and bottom plates and, may also comprise a single continuous piece so long as said upper and bottom plates, each plate having one or more grinding elements thereon, are reciprocally movable relative to each other such that grinding of the smokable substance to a desired fineness can be achieved. In another embodiment, said plates and may be movably affixed to the grinder's interior wall using any suitable means known in the art, including, but not limited to, a screw, rivet, clasp, hook, or latch. In one embodiment, the surrounding edge of the front surface of the upper and lower plates, and, may comprise an angle which securely and rotatably fits between the side wall of the grooves along the interior walls of the grinder 3. Said plates, with one or more grinding elements 29 thereon the front surface, can also be movably affixed to each other, or each individual plate may be movably secured in the interior of grinder 3 by any other manner known in the art, so long as each plates can engage in reciprocating motions relative to each other in order to ground the smokable substance when said plates are activated to achieve a desired fineness without any interference.

In yet another embodiment, the grinder 3 may be coupled to an electrical power source, including an electrical motor 14, preferably a DC motor, which in turn receives power from, for example, an electrical power source, such as an internal rechargeable battery 2. An alternative electrical power source may also include plugging an electrical cord from the smoking accessory device 1 into an electrical socket or plugging a USB cord into a live USB port. Also, motor 14 is coupled to the electrical power from the electrical cord when it is plugged in an electrical socket or a USB cord is plugged into an active USB port.

In another alternative embodiment, when the motor 56 is powered by the power source, the motor 56 actuates the one or more grinding elements 29 to move in a manner sufficient to grind the smokable substance to a desired fineness, or at least grind the substance in a form suitable for smoking by any means, including, but not limited to, a pipe, rolling papers, vaporizer, and bowl piece. The grinder 3 may further comprise an actuation button 57 provided on a touch bar or one or more stand-alone buttons on the external surface of the smoking accessory device 1. The actuation button 57 can be electrically coupled to the motor 56, which is electrically engaged with the grinding elements 29.

In one embodiment of the present invention, depressing the actuation button 57 results in turning on the motor 56, depressing the actuation button 57 again results in stopping the motor 56. Alternatively, the user can continually depress the button for continuous grinding. In one alternative embodiment, the grinding elements 29 can proceed continuously, intermittently or move at various speeds by depressing the actuation button 57 one or more times where each depression causes a change in the speed of the grinding elements 29 or the continuity of the grinding action, thus allowing the user to control the speed grinding elements 29 and the extent to which the material is ground.

Users may also manually adjust the settings for how they want their smokable substance ground by selecting, for example, a particular size, shape, and length of the one or more grinding elements 29. Alternatively, the desired grinding may be achieved by positioning rotating blades at either the upper, middle or lower portion of the grinder, where the blades are affixed in the grinder via means specified herein in relation to the grinding elements 29, and said blades are electronically coupled to motor, which may be powered by the various means discussed herein for the other components requiring a power source.

v. Manual Grinding

The smoking accessory device of the present invention may also comprise the ability to manually grind the smokable substance, as opposed to grinding such substance vi an electric powered grinder. In one embodiment, the amount of grinding of the smokable substance may be controlled manually by using an external lever 22 or crank handle (not illustrated) positioned on the external surface 6 of the smoking accessory device 1, thus enabling the user to manually churn the one or more grinding elements 60 inside the grinder 3 by turning said external lever 22 or crank handle (not illustrated) to achieve a desired fineness of the smokable substance.

In one embodiment, the manual grinder 58 may comprise two or more corresponding, opposing, complimentary, reciprocating, or male/female grinding elements 29 positioned on the front surface of the upper and bottom plates, and. The grinding elements 29, for example, of each plate may comprise multiple protuberances that can cooperate with or are complementary to each other such that when activated manually by an external lever or hand crank, each plates with multiple protuberances thereon, can then engage in a reciprocating motion in front of and relative to each other, thus effectuating the desired grinding of the smokable substance when the plates are manually actuated to move in such manner. Here, the external lever or hand crank (not illustrated) can be movably coupled to the upper and bottom plates, and, respectively, to enable the user to engage said plates to, for example, rotate in a reciprocating or opposite motion, which in turn causes the smokable substance to be ground to a desired fineness. In another embodiment, grinder 3 may comprise multiple plates that can engage in a reciprocally and/or cooperatively motion relative to the one or more grinding elements 29 on the front surface of each plate; where each plate has one or more grinding elements 29 and each grinding element is positioned on the front surface of said plates. When, for example, said two plates engage with each other in this manner, the one or more grinding elements 29 thereon thus form a grinding area 64 where most if not all of the grinding of the smokable substance takes place.

The one or more grinding elements 29 may comprise various configurations, sizes and shapes including, but are not limited to, an elongated, non-elongated, compact, stout, non-linear, diminutive, or truncated blade or knife. teeth, tooth, indented edge, peg, projection, spike, pyramids, rectangles, squares, circles, ovals, and other polygonal shapes in aligned or staggered arrangements. Each grinding element 65 may have one or more edges sufficient to grind the smokable substance to a desired level, where each edge may be sharp, serrated, toothed, notched, ridged, saw-toothed, striated, nicked, angular, bent, crooked, pitted, jagged, zigzagged. The one or more grinding elements 29 may have different or the same pitches or angles suitable for grinding the desired smokable substance or have no pitch or angle at all. Moreover, the reciprocating and/or complementary opposing grinding elements 29 on the front surface of the upper and bottom plates and can be perpendicular to each other, as well as acute or obtuse, among other configurations. One skilled in the art can select the desired shapes, sizes, pitches, configurations, angles, among other things, of one or more grinding elements 29 for optimum desired performance.

In yet another preferred embodiment, the present smoking accessory may include a DC motor 14, a push button switch or variable control switch 67, a recharging plug 68, and an internal rechargeable battery 2. The DC motor 14 provides the power, for example, to actuate the grinding elements 29 on the front surface of the upper and bottom plates in in the interior of grinder. The button switch 71 is configured to switch the power ON and OFF when pressed. When pressed, the push button switch causes the DC motor 14 to be started. When the button switch 71 is depressed, for example, the DC motor 66 stops. The recharging battery 2 allows recharging of the internal rechargeable battery 2 from an outside power source. In an alternative embodiment, the rechargeable plug 72 can accommodate the USB conductor 73. The internal rechargeable battery 2 provides the power to run the DC motor 14. The DC motor 66 provides, for example, the power to actuate the grinding elements to effectuate the desired grinding of the smokable substance. The button switch 71, when pressed, turns on the DC motor 14. When depressed, the push button switch turns off the DC motor 14. The recharging plug allows recharging of the internal battery 2 from an outside source of electricity, for example.

vi. Dispensing Ground Smokable Substance (After Grinding)

The ground smokable substance may be collected at and accessed from a dispensing port after said material is ground, from which point the ground substance can be dispensed from the smoking accessory device 1. In one embodiment, grinder 3 can be communicatively coupled to collection unit 73 such that the ground smokable substance can pass from grinder 3 into said collection unit 73. Once grinding is completed, the ground material may pass through collection unit 21 and into dispensing port.

Moreover, the ground smokable substance can be dispensed from the dispensing port by various non-limiting means discussed herein. Said dispensing port may comprise, for example, a top panel and bottom panel. Each panel having a front and back, as well as a lower and upper end. The width and length of each said panel, and, may be the same, substantially the same or significantly different. Optionally, the top and bottom panels may form an enclosure by having side walls running along each panels' outer edge, and. Said side walls can be used as, among other things, a means for facilitating containment and access to the smokable substance from the dispensing port. Also, in another embodiment, the dispensing port may comprise no top panel or sidewalls, or it may comprise a bottom panel and side walls along the bottom panel's outer edge, but no top panel. The dispensing port may also comprise a channel, tube, groove, slot, trough, hollow, chute or any other structural passageway suitable for receiving ground smokable substance from collection unit 21.

Further, the one or more components making up the dispensing unit, including but not limited to, those components mentioned herein, may further comprise means for accessing the ground smokable substance therein. Examples of non-limiting means to access the ground smokable substance may comprise, for example, a movable and/or openable section as part of the dispensing port, like a hatch, foldable section that creates an entryway, removable lid, hinged lid, portal, opening, or any other means for providing an entryway to access the ground smokable substance from the dispensing port. Further, the movable and/or openable section may be placed on the external surface of the dispensing port. Such sections of the dispensing port may also comprise a handle, knob, handgrip, crank, lever, trigger, foldable section on the external surface or any other structure that a user may grasp to move, lift, slide, push, pull, fold or otherwise manipulate in some form to effectuate a sufficient opening to access the smokable substance inside the dispensing port.

The dispensing port may be permanently, movably, hingedly, articulately, pivotally, or removably attached to the smoking accessory unit 1 of the present invention. Preferably, the dispensing port is linked to the collection unit 73, and more preferably, the dispensing port is at least partially hingedly affixed to said unit. For example, in one embodiment, the top and bottom panels, and, respectively, may be affixed to the external surface of the collection unit, and, in this embodiment, only the bottom panel is affixed to the side walls. The top panel is not. Also, in this embodiment, the length of the top panel may be longer than the length of the bottom panel such that the upper end of the top panel extends further than the upper end of the bottom panel. The top panel may also be movably affixed, and preferably the top panel is hingedly affixed to the collection unit 21. In another embodiment, the lower end of the top panel is preferably hingedly affixed to the external surface of the front side of the dispensing port, thus providing a movable top panel, where the user can access the ground smokable substance inside the dispensing port by lifting the upper end of the top panel (which extends over or beyond the upper end of the bottom panel) in an upward motion, thus providing access to said ground substance inside the dispensing unit. In yet another embodiment, the upper end of the top panel may be curved downwards or upwards to provide means for grabbing the top panel and lifting it an upward motion to provide access to said ground substance in the dispensing port. Further, the external surface of the top panel may also comprise a handle, knob handgrip, crank, lever, trigger or any other structure that a user may grasp to open the dispensing port for access to the ground smokable substance inside.

Other movable linkage systems suitable for movably linking the dispensing port, or any component thereof, to any part or section of the present invention, including, but not limited to the collection unit, can be used. More particularly, such other linkage systems can be used to communicatively link the collection unit with the dispensing port. Such linkage systems include, but are not limited to, a clasp, hinged bracket, hinged joint, articulating joint, pivot connection, swivel joint, or any other means that would enable the user to manipulate the position of either the top or bottom panel in order to form a sufficient opening in the dispensing port, such that a user can access the ground smokable substance inside. Most preferably, the top panel may be hingedly connected to the external surface of collection unit 21. In one alternative embodiment, the width of the top panel and bottom panel is the same. Moreover, said top and bottom panel each further comprising a top end and bottom end, where at least one top end, or both, of each said panel may be affixed or removably affixed to the external surface of collection unit 21. More preferably, the dispensing port can be attached to the external surface of the front side of collection unit 73. In another embodiment, the dispensing port may be joined to the bottom portion or underneath the collection unit 73. In another embodiment, the lower end of the bottom panel is non-movably affixed to the front side of collection unit 73, and in contrast, the lower end of the top panel is hingedly connected to the front external surface of collection unit 73.

Collection unit 73 and dispensing port, and more preferably the lower end of the front side of the collection unit and the lower ends of the top or bottom panel of dispensing port, may also be joined or movably joined by any suitable means known in the art, including, but not limited to, a screw, rivet, clasp, hook, or latch, among other means. Said ends of the top or bottom panel may also be welded, soldered, glued, or otherwise rigidly affixed to collection unit 21.

Other means for removably joining dispensing port to the collection unit 73, and more preferably to the lower end of the front side of the collection unit are further disclosed herein.

In another embodiment, the dispensing port may be communicatively joined to the collection unit 73 in order to control the amount of ground smokable substance to be dispensed from the dispensing port.

In the embodiments where the dispensing port comprises, for example, a channel, tube, groove, slot, trough, hollow, chute or any other structural passageway suitable for receiving ground smokable substance from collection unit 21 and dispensing same from dispensing port, then optionally each of these components may further comprise a movable section thereon or attached thereto and of sufficient size and/or configuration to enable a user to access the ground smokable substance inside the dispensing port.

Other suitable dispensing means not mentioned herein will become apparent to those skilled in the art upon reading the disclosures herein.

Collection unit 73 can be suitable for transporting the ground smokable substance. This is because collection unit 73 may be removably detached from other components making-up the present invention, and thus serve as a stand-alone, transportable storage container for ground smokable substance

Many of the features of the present invention relating to the grinding and storage of the ground and non-ground smokable substance can be fully automated, including, but not limiting to, automating the user's ability to:
(i) Select the smokable substances among the other substances in the multiple storage compartments 21 to be ground;
(ii) Control the amount of smokable substance to be released from the selected storage compartment 21 into in grinder 3 for grinding;
(iii) Control the amount of grinding of the preselected smokable substance inside grinder 3 based on controlling the amount of grinding time and grinding speed;
(iv) Control the amount of grinding of the smokable substance inside the grinder based also on selecting the type and/or number of grinding elements 29 to carry out the grinding process, which in turn enables the user to control the resulting fineness of the ground substance; and
(v) Control the amount of ground smokable substance to be dispensed from the collection unit 73 into the dispensing port;
(vi) control access to the ground smokable substance inside the dispensing port; and
(vii) Control the amount of ground material to be dispensed from the dispensing unit.

The smoking accessory of the present disclosure 1 may comprise a storage component 20, which may further comprise a base. Said base may be disposed above grinder 3 and in one embodiment and communicatively linked to grinder 3. comprising one or more capable of receiving one or more storage compartments 21. Storage compartments 21 may be attached or removably attached to each other. A spacer Each compartment along, yet a separating joint 76. The grinder 3 can further comprise a grinding chamber 77 for receiving one or more smokable substances from the one or more compartments 21. The grinding chamber 77 being inside the grinder interior housing 28. Said housing comprising one or more compartments 80 and a spacer 78 between each individual storage compartment 21, and an electric motor 14 coupled to and separated from the grinding chamber 77 by the spacer 78.

In general, a spacer is a solid material used to separate two parts in an assembly. Spacers can vary in size from microns to centimeters. They can be made of metal, plastic, glass and other materials. Shapes include flat sheet, cylindrical and spherical.

### 6. Audio Sound System

The smoking accessory device of the present disclosure may also comprise an audio sound system 4 to play, among other things, music, podcasts, messages, etc.

i. Basic Description of Audio Sound System

In one embodiment, the audio sound system comprises one or more speakers. The one or more speakers may comprise a speaker module, a sound generation unit, a control unit for controlling the sound generation unit to generate sound, and a housing for accommodating the sound generation unit and the control unit. The sound generation unit can generate sound according to control signals transmitted from the control unit. The control unit is electrically connected to the sound generation unit for generating the control signals according to received audio signals, and transmitting the control signals to the sound generation unit, in order to control the sound generation unit to generate sound. The control unit can comprise a wireless module (e.g., chip), such as a Bluetooth chip, for receiving audio signals wirelessly from an external electronic device, including but not limited to a smart phone, tablet, mobile hand-held device. The housing is for accommodating the sound generation unit and the control unit. The control unit may comprise a plurality of buttons. The control unit may also comprise a wireless chip for receiving audio signals wirelessly. The housing having a sound emitting area formed with a plurality of through holes corresponding to the sound generation unit.

ii. Bluetooth Enabled

In another embodiment the audio sound system 4 can be operated via Bluetooth, wherein, an audio amplifier 38, a speaker module 39, an electronic control module 41, a Bluetooth module 44 and a microphone circuit 45 can be disposed inside one or more areas, or preferably in a single unit, including but limited to, an electrical unit 46 (e.g., electrical box). The Bluetooth module 44 may connect wirelessly with a mobile terminal for transmitting audio signals and answering calls of the mobile terminal. The audio amplifier 38 having an output connected to the speaker module 38. The Bluetooth module 44 can have an output connected to an input of the audio power amplifier 38. The Bluetooth module 44 can be connected to the microphone circuit 45; and the electronic control module 47 can be connected to and control the audio power amplifier 38, the Bluetooth module 47, and the LED. This alternative embodiment may also comprise a Bluetooth switch 48 to control one or more features of the audio sound system, including, for example, a volume control key; a last song key, and a next song key, among others.

Also, an indicator light, a power switch and a thin film switch can be included with the present invention. The electronic control module 47, the Bluetooth module 47, and the electronic control module 47 may be disposed on a printed circuit board (“PCB”). A speaker module may be installed inside the audio sound system or it may be removably attached to the smoking accessory device.

iii. Wi-Fi Enabled

In another preferred embodiment, the audio sound system may comprise at least one communication module, a wireless communication module (not illustrated) and a wireless LAN communication module (not illustrated). Here, the communication module (not illustrated) is a communication module for performing data communication wirelessly with an external module comprising, for example, a Bluetooth module, a ZigBee module or an NFC module, etc. Further, the wireless LAN communication module (not illustrated) is a module configured to be connectable to an external network according to wireless communication protocols known in the art, such as Wi-Fi and the like, to perform communication. Besides the aforementioned, the audio sound system may further include mobile communication modules configured to be connectable to a mobile communication network according to various mobile communication standards such as 3G, 4G, 5G, LTE (Long Term Evolution) and the like to perform communication.

For instance, the audio sound system for use with the present invention can also be Wi-Fi enabled, thus having the ability to access or connect to a network using radio waves, without needing to use wires. Such access will allow the audio sound device to connect to the Internet or communicate with one another wirelessly, or enable the audio sound system to connect to computers, smartphones, or other electronic devices through the Internet.

In one embodiment, the audio sound system of the present invention can be Wi-Fi enabled, and may further comprise, for example, a Wi-Fi enabled speaker, which can be removably detached from the present invention and thus transportable. A Wi-Fi enabled speaker can be linked to a user's electronic mobile device (e.g., smart phone or tablet) using methods known in the art. In another embodiment, the audio sound system is Wi-Fi compatible and thus can connect to, for example, the Internet via a WLAN and a wireless access point. The one or more Wi-Fi enabled speakers may be positioned in various places inside the audio sound system, or said speakers may be stand-alone units which can be removably attached from any section of the present invention. Most preferably, said speaker may be positioned on top or on the side the audio sound system. The speakers may also work remotely or wirelessly and thus, the speakers may be placed in locations away from the audio sound system.

iv. Downloading Music

In one embodiment, the audio sound system can allow the user to download and/or store electronic content, including but not limited to, music, into an electronic app/i-cloud-data platform or the like using procedures known in the art. More preferably, the electronic content can be stored within the audio sound system, or the music may be downloaded into one or more users' mobile electronic devices or headphones, for example, thus allowing the users to share and/or play their music through the audio sound system. The music can be down loaded from, for example, several music Apps, including but not limited to Pandora, Apple Music app, iTunes, I Heart Radio, Spotify, Amazon Music, Soundcloud, Google Play, Mixradio, Datpiff, Cymbal, Apple Music, TIDAL, YouTube Music, TuneIn Radio, Deezer, among others The music or other content is downloaded remotely or wirelessly, but it can also be manually downloaded.

v. Adjust Quality of Audio Sound

Users can manually or remotely adjust the quality of the sound emanating from the audio sound system via an App (a/k/a an Audio Control App.) downloaded, for example, on a mobile electronic device or computer. The App can also allow a user to manually customize the sound from the one or more speakers of the audio sound system, specifically directed to, among other things, controlling the sound quality from the audio sound system. In one embodiment, this requires that the user successfully downloaded the App onto a mobile electronic device or computer. The user can then register, sign in, and then wirelessly pair his/her mobile electronic device (e.g., smart phone or tablet) or computer to the audio sound system. In another embodiment, the App allow users to remotely turn on the power for the one or more speaker modules, control the audio volume, and customize the EQ (Equalization) of the music. EQ includes, among other things, the process of boosting or attenuating certain frequencies of a given audio signal. Adjustable equalizers may be used in connection with the present invention to boost or cut bass or treble frequencies.

In another embodiment, the default EQ setting for the audio sound system may allow the sound quality to be leveled/standardized (e.g., bass, tremble, loudness, balance, etc.). Based on the user's preference of sound, the App may provide the user the option to choose their preferred sound quality or provide the optimal sound they desire. The App may also provide presets for users to choose the type of sound they want to hear: e.g., bass driven sound, voice dominant sound, sound custom to room size (small room, big room, etc.) and more. The sound quality may also be controlled by manually manipulating the control constituents associated with or linked to the audio sound system, and/or the one or more speaker modules associated therewith. The sound quality may also be controlled wirelessly by other means known in the art, including but not limited to, voice activation, smart home technology, mobile electronic device, tablet and smartphone.

In addition, a lighting system (e.g., LED lighting system) may be installed as part of the audio sound system, where users can customize the lighting system through various means, including but not limited to an App., hand-held remote control unit, and touch control panel on the smoking accessory device. For example, the light settings can be remotely or manually adjusted, allowing the users to choose the colors to display, as well as the patterns/sequence of said colors to be synced with the music being played. The lights may also be turned off if the user so chooses by, for example, depressing button 18 on the external surface of the present invention or presented on the touch bar. In another preferred embodiment, an LED lighting system can optionally pulse with music. In yet another embodiment, the user can customize the settings and make the sound quality personal to their needs and tinker with the lighting display (e.g., LED) for the audio sound system at their discretion.

In yet another embodiment of the present invention there is an audio sound system which comprises a voice recorder that records voices when spoken or sung into or around the audio sound system.

### Making a Playlist

The smoking accessory device may comprise the ability that enables a user to make a music playlist. For example, in one embodiment of the present invention, the audio sound system may include a memory, a wireless communication unit and a controller. The memory stores first data including at least one music information. The wireless communication unit receives, from an exterior device, second data including at least one music information. The controller forms an integrated music list using the first and second data. In the audio sound system of the present invention, the user may perform a control method including comparing a plurality of music information constituting the first and second data; extracting overlapping music information included in the first and second data; and selecting one music information from the pair of overlapping music information. Thus, a user can form a desired music list.

vi. Voice Activation

The smoking accessory device may further include a voice activated control system that identifies voice characteristics of a voice (e.g., voice commands) to control various features of the smoking accessory device (e.g., grinding, audio sound system, among other features). In one embodiment, one skilled in the art may incorporate smart home technology and/or skills in the smoking accessory device to enable a user to control and/or automate various features of the smoking accessory device using voice commands. In another embodiment, various voice activated capabilities can be extended to the smoking accessory device by developing and/or installing “skills” (i.e., additional functionality). In yet another embodiment, one skilled in the art may incorporate smart home technology and/or skills in the smoking accessory device using the Alexa Skills Kit to enable a user to control various features of the smoking accessory device using voice commands.

In another embodiment, the smoking accessory device 1 can be voice activation enabled. This may be achieved, for example, by integrating Alexa voice capabilities and/or functionalities into the smoking accessory device of the present invention by using the commercially available Alexa Voice Service (AVS), which is a cloud-based service that provides APIs to interface with Alexa. Particular capabilities and/or functionalities built using AVS have access to Alexa's existing capabilities/functionalities including all of the Alexa Skills. AVS provides cloud-based automatic speech recognition (ASR) and natural language understanding (NLU) to enable the desired voice activation. Amazon's Blueprints may also enable individuals to build and integrate particular skills into the smoking accessory device to enable a user to control various features of the smoking accessory device using voice commands.

In other embodiments, the smoking accessory device may comprise a synchronization mechanism, including but not limited to, Wi-Fi, Bluetooth RTM., etc. The synchronization mechanism may be compatible with various devices, such as Amazon Alexa, Siri, Google Home, Google Assistant, Amazon Echo, Cortana, Bixby, etc. As such, the smoking accessory device may be communicatively connected to one or more of these home automation systems to facilitate and control the interoperability of one or more functions of the smoking accessory device. In yet another embodiment, the smoking accessory device may comprise an audio input interface, which may further comprise one or multiple microphones for picking up on surrounding audio, including speech expressed by a user. The voice command processor may be configured to receive the audio data from the audio input interface, and analyze the audio data received by the audio input interface, such as by performing speech recognition to identify and analyze, for example, speech vocalized by a user. The voice command processor may include those known in the art. The voice command processor may also be attentive to certain key trigger words, such as “Alexa.TM.” or “Google.TM.”, acting as a signal that the speech subsequent to the key trigger word will likely be a speech command (e.g. “Alexa, play [song name]”, “Google. TM., turn on lights as music plays.”).

The voice command processor may also access a user profile database to further analyze the speech of the user. The user profile database may contain information on a number of user profiles. For instance, this information may include, for a user profile, days on which the user often issues voice commands, a vocabulary typically used by the user, a language spoken by the user, pronunciation and enunciation of certain words by the user, and commands often issued by the user. This information on the user found in the user profile database may be further accessed by the voice command processor to assist with the identification of the user or to confirm the identity of the user.

In yet another embodiment, the smoking accessory comprises a response generator, which receives the recognized voice command of the user from the voice command processor and analyzes the voice command to provide an appropriate response. Such a response may be to send out an audible answer to the voice command, such as when the command is phrased as a simple question. The response generator may also launch an application program. The application program can be launched to carry out a designated function or response associated with the user's speech command. The application programs may be, for example, an audio player to output audio via speaker, or an application program that allows a user to place and answer telephone calls at the activation unit. For instance, the response generator may send out a response command to launch the media player application program when the user asks “Google, play Beethoven's Ninth Symphony”, and Beethoven's Ninth Symphony can be streamed by the activation unit, or is stored in memory of the activation unit as part of the user's music library contained in the activation uni. In another embodiment, the response generator may send out a response command which in turn allows the user to control the volume of the music, pause the playing of the music, and regulate the EQ. Other response commands may also include music playback, make telephone calls, activate the grinder, and search the internet hands-free and other tasks relating to the operation of the smoking accessory device.

vii. Headphones

Wireless headphones can receive sound (e.g., music) through a wireless connection to an audio sound system. Headphones capable of receiving and playing audio signals via Bluetooth, Wi-Fi or hardwire can be used with the smoking accessory device of the present invention. For example, in one preferred embodiment, one or more headphones can be configured to receive audio sound from the audio sound system of the present invention via wireless connections known in the art. In another preferred embodiment, the audio sound system of the present invention can provide wireless streaming of audio sound to headphones via Bluetooth or Wi-Fi. In yet another embodiment, the headphones can be configured so that a user can easily mute his/her own headphone speakers so that he/she can answer a telephone call, for example, without interrupting the other users listening to the same music from the same source on their respective headphones. In yet another preferred embodiment, a user can remotely or manually press an audio control button that can automatically mute one or more headphones wirelessly connected to the audio sound system of the present invention. In yet another embodiment, the smoking accessory device may comprise one or more sockets for receiving a connector, including but not limited to, a phone jack, audio jack, headphone jack or jack plug.

### Adjustable Legs for Smoking Accessory Device

The smoking accessory device may also comprise various means to adjust the height of the smoking accessory device, or any portion thereof, preferably the speakers for the audio sound system. In one preferred embodiment, one or more legs may be positioned underneath the removably detachable speakers. The length of the legs are adjustable in order to adjust the height of the speakers. There exists numerous adjustable leg assemblies suitable for the present invention, which are mechanically controlled by, for example, a protuberance-hole or screw-jack mechanism. Some installations employ mounted telescopic legs for controlling the vertical adjustment of smoking accessory device. These systems may employ telescopic tubes which conceal the actuators, be they mechanical, or electrical, such that the smoking accessory device, or portion thereof, is coupled to a fixed outer tube and a telescopic inner tube surrounds an actuator.

### 7. Control System to Operate the Grinder, Audio Sound System and Other Features

In another embodiment, the smoking accessory device of the present invention can be operated via a control system in the form of a touch bar display system on the external surface of the smoking accessory device 1. It may also be controlled by other means, including but not limited to a computing device, APP, hand-held remote control device, and voice activation. The computing device may include, but is not limited to, mobile computer devices

### Touch Bar Display

In one preferred embodiment, the smoking accessory device comprises a capacitive touch user interface panel, including but not limited to, a touch bar which may include, for example, a buttonless touch control panel. In one embodiment, the touch bar works by sensing when a fingertip is in contact with the screen. Said touch bar may be configured to control one or more functions of the present invention, whereby a particular function is represented by an appropriate icon or other indicia indicating the precise function/feature for which the indicia corresponds. Such functions and features include, but not limited to, controlling the grinder, audio sound system, lights (LED), storage containers, among other functions of the smoking accessory device 1. In some embodiments, the capacitive touch bar user interface panel can be positioned along the side or on top of the smoking accessory device 1.

In addition, the touch user interface panel may also comprise an indicator (not shown) to show current power level of the battery, where in at least one embodiment, the indicator comprises one or more colors according to predetermined power thresholds as well as on/off indicators showing when any particular function of the smoking accessory device is being operated.

i. Remote Control

In yet another preferred embodiment, one or more functions of the present invention can be controlled by a remote-control device. Remote controls can operate via infrared signals or by radio frequency signals received by sensor positioned in the device of the present invention. Infrared signals and radio frequency remote controls are widely used and well-known in the art. Regarding the present invention, the remote-control device may be configured to control a variety of functions, including but not limited to, the speed of the grinder, lighting, audio volume, EQ and other functions. In one embodiment, the remote control unit for use with the present invention may be carried out by infrared signals using an infrared diode that emits an invisible beam of light, typically a 940-nanometer wavelength LED.

A multichannel remote-control device can also be used with the present invention. In one preferred embodiment, the multichannel remote-control device can be configured to modulate carrier signals, demodulate the received signals, and use a variety of frequency filters to separate signals for various remote-control functions, as known in the art. However, these infrared signals need to be in line of sight to operate one or more functions of the smoking accessory device, and may be reflected by mirrors as would any other light source. Remote-control via radio frequency signals do not require line of sight to control one or more of said functions. They can be focused in one direction, or be multidirectional.

ii. App.

In another embodiment, one or more functions of the smoking accessory device can be maneuvered and/or controlled with ease through an App. For example, the App can provide the user the ability to change the speed of the grinder, choose the smokable substance within the container to be ground, customize music settings, and change the colors of the lights emitting from the device. Aside from efficiency; the App provides convenience and simplicity. Because there are multiple segments and functions that make up the device, the App. will alleviate the inconvenience associated with manually maneuvering, for example, knobs, switches or dials—positioned on the smoking accessory device—to adjust the volume of the sound emanating from the audio sound system, grinding speed, selecting which substance to be ground, and customize the lighting, among other features of the present invention.

Moreover, one of the various benefits of the App. includes, but is not limited to, alleviating the clutter of downloading multiple Apps on a user's smart phone which he/she does not use. On average, smart phone users have approximately 25 mobile apps on their phone, yet one three apps are primarily used day-to-day. The convenience of a compact App with three uses, for example, gives an appeal to the user, and reliance on the optimal use of the device from what is offered in the App. The App will also have off-line functions to operate, for example, the speaker and grinder.

In yet another embodiment, each segment of the smoking accessory device, including but not limited to, audio sound system, storage container, and grinder, can be removably attached to each other. Each such segment may comprise a tracking beacon therein, where the beacon in said segment is communicatively linked to a tracking App., such that the App. can track and locate one or more such segments in the event they are misplaced, lost or stolen. In another embodiment, one or more segments may comprise commercially available anti-theft tracking software installed therein, including but not limited to PhoneSheriff TM, Mobistealth TM, mSpy TM or FlexiSpy TM software. Such software can enable the user to track and locate a lost segment of the smoking accessory device. Also, this tracking software can be installed in the smoking accessory device of the present invention by known methods in the art.

The App also provides the user with the option to control the one or more speaker modules, install timers, sleep mode, and customize the App's interface. The App also may comprise one or more analytics that monitor and keep track of the user's usage of the smoking accessory device's various functions, and to provide suggestions for, including but not limited to, how to obtain the most output from these functions. For example, the App. can suggest the appropriate amount of time, grinding speed, and temperature needed to grind a particular smokable substance using the present invention. Such suggestions can be based on how the various functions of the smoking accessory device has been used over time.

### 8. Assembly: The Components of the Present Invention Can Be Removably Disassembled and Reassembled

The various segments of the smoking accessory device of the present invention (e.g., grinder, storage, battery, audio system, etc.) can be positioned next to each other in any order, and not all components specified herein need be present to practice the present invention. In one preferred embodiment, each component of the smoking accessory device can be disassembled and reassembled into one or more of its major constituents. That is, each individual constituent of the smoking accessory device described herein may be removably attached to each other in any practical order or arrangement. By way of example, a preferred arrangement of each major component of the present invention are relative to one another. It is also understood that one skilled in the art can ascertain, based on the disclosures herein, the order or arrangement of each constituent making up the smoking accessory device to accommodate her/his needs. Thus, the present invention is not and should not be limited to any particular order in which each constituent is arranged relative to one another.

One of ordinary skill in the art would understand that there exists various systems for connecting or removably attaching one component of the present invention (e.g., grinder) to another component (e.g., storage container). Thus, the present invention is not and should not be limited to any particular connection system in which one component is affixed, semi-permanently attached, or removably attached to another component.

Connecting systems suitable for the smoking accessory device include, but are not limited to removably coupling one component to another via an interference fit. In one embodiment, the interference fit, also known as a press fit or friction fit, enables fastening between two components by friction after the components are pushed together. In yet another embodiment, the interference fit between two components may be achieved where the external dimension of one side of the component slightly exceeds the internal dimension of the other component into which it has to fit when pressure is applied. The two components may be removably detached by applying sufficient force to both components in opposite directions or slightly rotating each component in opposite directions, where for example, one component is rotated in a clock-wise direction and the other component is rotated in a counter clock-wise direction.

In another embodiment, one segment may be affixed or removably attached to another segment via a snap-type attachment, such that two segments may be snapped together for semi-permanent attachment until a sufficient amount of force is applied to disengage them. In a snap-type fitting, one segment can be rotatable relative to the other segment without significant mechanical impedance. In yet another embodiment, one segment can be affixed or removable attached to another segment, where one segment comprises a one or more detents. The detent is configured to engage with a flange appropriately positioned to receive the other segment, permitting both segments to be rotationally locked together by applying sufficient force in, for example, a clockwise direction. The components can be detatched from each other by applying sufficient force in, for example, a counter clock-wise direction. The components of the smoking accessory device can be removably attached to another component via magnets positioned on at least one side of the components.

In one particular embodiment, the grinder can be detached and separately removed from the smoking accessory device such that it can be used independently of said device. Moreover, each segment of the present invention can engage with another said segment via a snap-type attachment, such that, for example, the audio sound system and the grinder are snapped together for semi-permanent engagement until a sufficient amount of force is applied to disengage them. In a snap-type fitting, for example the audio sound system can be rotatable relative to the grinder.

In yet another embodiment, the smoking accessory of the present invention comprises a grinder, storage container for the smokable substance and an audio system comprising one or more speakers. Each of these segments can be removably connected to another component and removably disconnected from each other. The ability to removably disconnect one component from another enables the user to transport one or more of said components separately. For example, the user can choose to remove the grinder in order to grind smokable substances elsewhere, or the user can remove the audio system (comprising one or more speakers) to another location to listen to music.

In another embodiment, the smoking accessory device of the present invention may be arranged as a single unit, a grinder, storage container and audio system having a cylindrical and sleek design. This design can enable the smoking accessory device to be sufficiently discreet such that it can blend in with common household items without drawing unwanted attention to the one or more smokable substances stored therein. In another embodiment, one or more segments can be removably disconnected such that the smoking accessory device of the present invention can fit into a stylish, yet convenient travel accessory.

Other means for removably attaching one segment of the present invention to another may be used. For instance, one segment can be affixed to another component via other fastening mechanisms know in the art. Such fastening mechanisms may include, but are not limited to, an adhesive, brazing or soldering, or via fasteners such as screws.

### 10. Electronic Circuitry for the Present Invention

The electrical components of the present invention, including but not limited to, the grinder, audio sound system, LED, storage, battery, among others, can accomplish their intended electronic functions by various means known to those skilled in the art, including but limited to, using one or more PCBs (Printed Circuit Board). Given that there are many known standards and guidelines that can be used for the design and layout of a PCB, it is understood that those skilled in the pertinent art can design a PCB(s) suitable to enable each electrical components of the present invention to receive the necessary signals and power to perform their intended functions without undue experimentation.

In another alternative embodiment, the internal rechargeable battery 2 may comprise one or more first conductors 81 to provide electric current to the electric motor 14. A recharging plug 82 coupled to the internal rechargeable battery 2 to recharge the internal rechargeable battery 2 and having one or more second conductors 83 for connecting to an external power supply 7, thereby enabling recharging of the internal rechargeable battery 2. Such embodiment may also comprise a control switch and a two-condition control switch 84 (e.g. a two condition control switch), a relay 85 having at least one pair of openable and closable contacts, and third conductors 86 electrically interconnecting the electric motor 14, the control switch 84 (e.g. a two condition control switch), and the relay 85 with the internal rechargeable battery 2.

In one embodiment, the electronic components used in the present invention may be mounted on or communicatively connected to a PCB and one or more traces can connect the components together to form a working circuit or assembly. The PCB may comprise one or more non-conductive materials with conductive lines printed or etched. In another embodiment of the present invention, the electrical components may be electrically connected to each other, and/or electrically connected to the same control panel(s) and/or power source(s), via a PCB(s). The PCBs may comprise, for example, one or more known elements using conductive traces, tracks, pads, and other features printed or etched from, for example, sheets of copper foil laminated onto a non-conductive substrate. The PCB's may be single sided (e.g., one copper layer), double sided (e.g., two copper layers), or multi-layer (e.g., outer and inner layers). Multilayer PCB with 4-layers and 6-layers is typical. Conductors on different layers may be connected with plated-thru holes. Other types of PCBs that can be used in connection with the present invention comprise Rigid PCBs, Flexible PCBs, Rigid-Flex PCBs, High-frequency PCBs, and Aluminum-backed PCBs.

An electronic control unit may control one or more of the electrical systems or subsystems in the present invention. Said control unit may be disposed inside one ore individual components or segments of the smoking accessory device of the present invention. The electronic control unit may comprise a grinder control module, Bluetooth control module. . . . Said electronic control unit may incorporate one or more individual control modules.

### 11. Stowage Compartment for Other Smoking Accessories

In a preferred embodiment, the present invention may further comprise one or more stowage compartments which are configured to receive various smoking related accessories and/or tools, including, but not limited to, rolling papers, matches, rolled-up smokable substance, Vaporizer, charger for Vaporizer, bowl piece, packing tools, lighters, including but not limited to lighters by Clipper and other brand names. Said stwage compartment can be positioned virtually anywhere on the external surface of the present invention, including the front, back, top, bottom and the sides of the present invention. In one embodiment, the stowage compartments can afford additional stowage space for the orderly safekeeping of smoking related accessories and/or tools, as well as provide them within easy reach of the user. The one or more stowage compartments can be mounted on or removably affixed to the exterior or interior surface of the smoking accessory device. The one or more stowage compartments may further comprise hinged covers for opening and closing said compartments.

In one embodiment, a stowage compartment can be mounted on or removably affixed to the exterior or interior of the smoking accessory device, comprising: a lower compartment section for receiving articles to be stowed; an upper compartment section serving as an outer cover for the lower compartment section; said upper compartment section being fixed to the exterior of the smoking accessory device, and said lower compartment section being pivotal to a closed position or to an open position with respect to said upper compartment section; and which may comprise a compartment locking mechanism for locking said two compartment sections together when the lower compartment section is in its closed position with respect to the upper compartment section; said compartment locking mechanism may include a handle manually engageable by a user for releasing the compartment locking mechanism to permit pivoting the lower compartment section to its open position with respect to the upper compartment section.

In yet another embodiment, the one or more stowage compartments may be removable.

For example, said removable stowage compartments include, but are not limited to, a removable stowage compartment in the form of a sliding drawer, where said compartment is configured to accommodate a range of smoking related items. In one such embodiment, a stowage compartment may comprise a lid; a storage drawer which is guided via track guide, and a driving element for driving the storage drawer forward on opening the lid, wherein the driving element is attached to the lid on one portion and is connected to the storage drawer on another portion. The compartment lid may be actuated by way of a pull rod. The guide for the storage drawer may be provided at least in part on an inner surface of the lid.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The alternative embodiment may also comprise one or more dispensing reservoirs 35 to provide access to the ground smokable substance. Specifically, said ground substance can be dispensed from the reservoir by way of a pull drawer, or movable plate which can be manually pulled outward or the plate containing the ground material can be moved electronically outward from the smoking accessory device to provide the user access to the ground material. This may be achieved by known methods in the art.

The pull drawer may comprise a lid 33a and handle 33b. The dispensing reservoir may be moved outwardly by depressing ejection button 33c.

The compartment located on the side of the speaker is a holder for the rolling papers. The papers are able to be stored on the side of the speaker in an area called the paper storage/dispenser. The paper storage dispenser can be located on the width side of the speaker and can be dispensed like a sidewalk mail box or a glove compartment in a car. The compartment will operate as a hinge to comfortably slide open and closed with the ability to dispense out joint papers like a printer or harbor joints, rollup, backwoods cigarillos and smoking packaging as a placeholder.

### Collection Unit for Ground Smokable Substance

In between the bottom of the container and the top of the grinder, the middle ground will act as a filtration system/doorkeeper positioned between the container and grinder to control the inflow of weed from the container to the grinder. This middle area between the container and grinder components act to prevent excess/undesired amount of weed to be grinded (like a gumball machine). The container will release the desired amount of buds into the grinder where the metrics of weight/quantity of dispensable ground material can be measured. the weed can be measured by a sensory scale/weighing machine that can estimate/keep track of the amount of smokable substance already grinded and the remaining amount of weed needed to complete. The total amount of bud grinded can be viewed on the app and the touch bad where the display will show the incremental weight of the actively grinded weed until the desired amount of grinded material is finished.

In one embodiment, a pull-down compartment maybe disposed on the external side of the speaker or located on an outside surface of the stowage compartment. In another embodiment, the pull down compartment is located on the external side of the speaker. The stowage compartment door is able to be seen on the side of the speaker where a button, located next to the stowage compartment door and can eject the latch holding the stowage door together. This can be used to store, for example, rolling papers and other smoking related accessories. The drawer-like compartment may comprise a bottom surface, front panel and back panel, and a knob or handle on the outer surface of the front panel. The drawer-like compartment further includes side walls along the outer side edges of said bottom surface. The drawer-like compartment further includes a roller stowage on the outer surface of each side wall. In another embodiment, a telescopic track may be disposed on the interior wall of the apparatus. The shape and configuration of each guide may be fitted to movably engage along said tracks, preferably in a sliding or rolling motion, when the front panel is opened or closed.

For example, the telescopic track may be communicatively coupled to the drawer-like compartment, where, for example, said tracks may be communicatively linked to the backside of the front panel via a linking member which includes, but is not limited to, a wire, cord, cable, line or an elongated rod, such that when the drawer-like compartment is opened by pulling the knob or handle in a downward motion (much like opening a mailbox), the linking member can then exert sufficient force to cause the telescopic tracks to extend forwardly whereby the guides on each side of the drawer engage with the projected tracks and move along these tracks (e.g., roll or slide) while the drawer continues to be pulled downward. As a result, while the front drawer panel is pulled downward, the draw-like compartment extends outwardly at the same time. Once the projected tracks have reached maximum extension, the front draw panel cannot be pulled downward any further, and the draw-like compartment is now fully open and accessible. Closing the drawer-like compartment comprises pulling said knob or handle an upward motion, thus causing the drawer guides to move along the retracting tracks (e.g., roll or slide) until the tracks cannot retract any further. At the same time, said drawer-like compartment stops moving backwards, and at that point, the front panel is completely upright, and consequently, the draw like compartment is closed. In yet another embodiment, said tracks arc disposed on the outer side walls or bottom surface of the drawer-like compartment.

In yet another embodiment, the rolling papers may be stored in said pull-down compartment, where said compartment is suitable for storing and dispensing rolling papers. For example, individual rolling papers can be dispensed by pulling the drawer-like compartment downwardly, thus causing a single rolling paper to be dispensed and accessible for immediate use.

The stowage glove compartment for rolling papers will be built inside of the speaker. An eject button will be located next to the door. The door (once opened, will be able to fall downwardly to a 60 degree angle. The button is a pushbutton switch. The push button switch will activate an electrical circuit when pressed on. When the push switch button is activated, electrical circuits will flow into wires which connect to the clamp inside the stowage compartment which will open the box. The same button can close the box by triggering spring back to its original position.

### Rolling Paper Dispenser (With or Without Pull Down Drawer Effect)

In another embodiment, a rolling paper dispenser device may be disposed inside the one or more draw like compartments. Said device may comprise a front and rear wall and two side walls. Said front wall having an elongated vertical slot thereon permitting access of a single sheet of rolling paper therethrough. Said dispensing device may further comprise a bin for storing and supporting multiple sheets of rolling papers, preferably at least 50 sheets of rolling papers, more preferably at least 100 sheets of rolling papers, where each sheet is placed on top of another while inside the bin. Two opposing spindles are disposed inside the dispensing device near or adjacent to said slot, preferably immediately adjacent thereto, and the other side of said spindles is disposed near or immediately adjacent to said bin. The bin and the two opposing spindles may be fastened inside the dispensing device via conventional fastening means known in the art, including, but limited to, a screw, rivet, clasp, hook welding, soldering, gluing, among other means. Said opposing spindles may also be fastened inside the bin, preferably near or immediately adjacent to said slot. The rolling paper dispenser may also comprise a cam means for camming a single rolling paper from the bin and then forcing said rolling paper between said opposing spindles in a manner that allows a portion of said rolling paper to protrude through the slot, thus making said rolling paper accessible for use. Each time a single rolling paper is pulled from the slot disposed on the front wall of the dispensing device, said cam means may again force a subsequent rolling paper from the bin and through said opposing spindles so that a portion of said subsequent sheet of rolling paper is forced outward and protrudes through said slot, at which point the subsequent protruding rolling paper is now accessible for use, and when this sheet of rolling paper is pulled from the slot, then another portion of a sheet of rolling paper will be accessible from the slot by the same means discussed herein. The dispensing action of the rolling paper dispenser will continually repeat itself provided the bin contains sheets of rolling papers.

Certain embodiments are operated by steps of i) the button will trigger the chip to connect to the paper dispenser to turn on; ii) the electronic circuit (almost a tiny computer of its own) will tell the dispenser how many papers should be dispensed; iii) the electrical circuit will activate a corona wire which gives an electrical current near anything close by; and iv) the circuit will activate the roller to churn out a piece of paper.

The present invention also comprises a pocket on the external side of the smoking accessory device. Said pocket comprising an opening. The pocket also comprises a movable flap fastened to the external surface of the smoking accessory device. Said lid being disposed immediately above said pocket. In one embodiment, the flap may comprise a female or male portion of a latch system, which fits inside the corresponding female or male portion of said latch system on the front surface of the pocket. When said male and female portions are fitted together, the latching system is complete, and, as such, said pocket opening is securely closed by the flap. In another embodiment, the pocket comprises enough space to fit small accessories inside.

The present invention may also comprise means for attaching protective gear on top of the speakers. Like a lid that shields the inside of a car from the blazing heat, which can be emit ted inside the car through an open sunroof. The protective gear can operate like a guardian. If somebody is underneath the sun at the beach, the protective dorsal gear will protect the smoking accessory device of the present invention from: (i) overheating; (ii dirt invasion or contamination; and iii) water damage (i.e., water or moisture getting inside the device). In another embodiment, the smoking accessory device is waterproof.

In one embodiment, a pull-down compartment may be disposed on the external side of the speaker or is located on outside surface of the apparatus and can be used to store, for example, rolling papers and other smoking related accessories. The drawer-like compartment may comprise a bottom surface, front panel and back panel, and a knob or handle on the outer surface of the front panel. The drawer-like compartment further comprising side walls along the outer side edges of said bottom surface. The drawer-like compartment further comprises a guide (e.g. roller) on the outer surface of each side wall. In another embodiment, a telescopic track may be disposed on the interior wall of the apparatus. The shape and configuration of each guide may be fitted to movably engage along said tracks, preferably in a sliding or rolling motion, when the front panel is opened or closed.

For example, the telescopic track may be communicatively coupled to the drawer-like compartment, where, for example, said tracks may be communicatively linked to the backside of the front panel via a linking member which includes, but is not limited to, a wire, cord, cable, line or an elongated rod, such that when the drawer-like compartment is opened by pulling the knob or handle in a downward motion (much like opening a mailbox), the linking member can then exert sufficient force to cause the telescopic tracks to extend forwardly whereby the guides on each side of the drawer engage with the projected tracks and move along these tracks (e.g., roll or slide) while the drawer continues to be pulled downward. As a result, while the front drawer panel is pulled downward, the drawer-like compartment extends outwardly at the same time. Once the projected tracks have reached maximum extension, the front draw panel cannot be pulled downward any further, and the drawer-like compartment is now fully open and accessible. Closing the drawer-like compartment comprises pulling said knob or handle an upward motion, thus causing the drawer guides to move along the retracting tracks (e.g., roll or slide) until the tracks cannot retract any further. At the same time, said drawer-like compartment stops moving backwards, and at that point, the front panel is completely upright, and consequently, the drawer-like compartment is closed. In yet another embodiment, said tracks are disposed on the outer side walls or bottom surface of the drawer-like compartment.

In yet another embodiment, the rolling papers may be stored in said pull-down compartment, where said compartment is suitable for storing and dispensing rolling papers. For example, individual rolling papers can be dispensed by pulling the drawer-like compartment downwardly, thus causing a single rolling paper to be dispensed and accessible for immediate use.

In another embodiment, a rolling paper dispenser device may be disposed inside the one or more drawer-like compartments. Said device may comprise a front and rear wall and two side walls. Said front wall having an elongated vertical slot thereon permitting access of a single sheet of rolling paper therethrough. Said dispensing device may further comprise a bin for storing and supporting multiple sheets of rolling papers, preferably at least 50 sheets of rolling papers, more preferably at least 100 sheets of rolling papers, where each sheet is placed on top of another while inside the bin. Two opposing spindles are disposed inside the dispensing device near or adjacent to said slot, preferably immediately adjacent thereto, and the other side of said spindles is disposed near or immediately adjacent to said bin. The bin and the two opposing spindles may be fastened inside the dispensing device via conventional fastening means known in the art, including, but limited to, a screw, rivet, clasp, hook welding, soldering, gluing, among other means. Said opposing spindles may also be fastened inside the bin, preferably near or immediately adjacent to said slot.

The rolling paper dispenser may also comprise a cam means for camming a single rolling paper from the bin and then forcing said rolling paper between said opposing spindles in a manner that allows a portion of said rolling paper to protrude through the slot, thus making said rolling paper accessible for use. Each time a single rolling paper is pulled from the slot disposed on the front wall of the dispensing device, said cam means may again force a subsequent rolling paper from the bin and through said opposing spindles so that a portion of said subsequent sheet of rolling paper is forced outward and protrudes through said slot, at which point the subsequent protruding rolling paper is now accessible for use, and when this sheet of rolling paper is pulled from the slot, then another portion of a sheet of rolling paper will be accessible from the slot by the same means discussed herein. The dispensing action of the rolling paper dispenser will continually repeat itself provided the bin contains sheets of rolling papers. [Identify where the cam is located, and explain its actuation in regard to forcing a single sheet of rolling paper from the bin and then between the opposing spindles so that a portion of the rolling paper appears in the slot and said paper I accessible.]

The present invention also comprises a pocket on the external side of the smoking accessory device. Said pocket comprising an opening. The pocket also comprises a movable flap fastened to the external surface of the smoking accessory device. Said lid being disposed immediately above said pocket. In one embodiment, the flap may comprise a female or male portion of a latch system, which fits inside the corresponding female or male portion of said latch system on the front surface of the pocket. When said male and female portions are fitted together, the latching system is complete, and, as such, said pocket opening is securely closed by the flap. In another embodiment, the pocket comprises enough space to fit small accessories inside.

### Protective Gear

The present invention may also comprise means for attaching protective gear on top of the speakers. Like a lid that shields the inside of a car from the blazing heat, which can be emitted inside the car through an open sunroof. The protective gear can operate like a guardian. If somebody is underneath the sun at the beach, the protective dorsal gear will protect the smoking accessory device of the present invention from: (i) overheating; (ii) dirt invasion or contamination; and (iii) water damage (i.e., water or moisture getting inside the device).

In yet another embodiment, the preferred design of the smoking accessory device of the present invention may comprise many shapes, including but not limiting to, a cube, elongated cylinder, polygonal, which includes, but is not limited to, rectangular, octagonal, hexagonal, or pentagonal. Also, in another embodiment, any polygonal shape suitable for the present invention may be sleek and extend vertically or horizontally, or a combination of both. The surface appearance of the present invention may present in many forms, including, but not limited to, sleek, lustrous, smooth, polished, matt, silky, trim, among other surface types.

### Aesthetic Plastic Wrap

The present invention may also be concealed with an aesthetic plastic wrap. Such wrap may cover the smoking accessory device for marketing and other purposes, such as insulation and to serve as a humidity barrier.

In one embodiment, the flow of non-ground and ground smokable substance from compartment 21 and collection unit 73 into grinder 3 and dispensing port 73, respectively, may be regulated and/or controlled based on the weight of the non-ground substance as it is discharged from compartment 21 or collection unit 73, respectively. In another embodiment, an electrical weight sensor suitable for receiving and accurately weighing non-ground and ground smokable substance may be disposed between compartment 21 and grinder 3, as well as collection unit 73 and dispensing port. The electrical weight sensor may digitally display the accurate weight of said substance as it is discharged from compartment 21 and/or collection unit 73. In one embodiment, the electrical weight sensor is disposed between the bottom end of compartment 21 and top portion of grinder 3, as well as collection unit 73 and the top end of the dispensing port.

The means for measuring the weight of said substance may also include, but is not limited to, a high-precision electronic weight sensor, or preferably a digital electronic scale in the form of a high precision weight sensor to ensure more accurate readings. Said weight sensor may be electronically and communicatively coupled to a digital LCD display, which is disposed on the external surface of the smoking accessory device 1. In another embodiment, the digital LCD display may appear on the touch screen display 24. In a further embodiment, a high precision electronic weight sensor for tracking the weight of the smokable substance as it is discharged from compartment 21 and/or collection unit 73 and accumulates in a receptacle, including but not limited to, a plate, disc or plane. Said receptacle may be disposed on top of or immediately above the weight sensor, and while the substance accumulates thereon, the sensor sends an electronic signal reflecting the accurate weight of the non-ground or ground substance to a digital LCD display, where the weight is numerically specified in grams. Said means for measuring the weight of the non-ground and ground substance is at least substantially accurate, preferably within 0.01 grams to 1.0 grams.

In another embodiment, the total weight of ground or non-ground smokable substance can be viewed on a touch display or an App on a mobile electronic device. The display or App will show the incremental weight increase while the smokable substance is being actively ground in grinder 3 or being released into dispensing port, respectively, until the desired amount has been released, at which point said release of smokable substance from compartment 21 or collection unit 3 stops.

Controlling the Amount of Smokable Substance Released from a Storage Compartment 21 or Collection Unit 73 By an Open and Closed System

In yet another non-limiting embodiment, the present invention provides means for controlling the amount of ground and non-ground smokable substance to be released from either compartment 21 and collection unit 73 into grinder 3 and dispensing port #, respectively. Such control can be achieved by, for example, using an open and closed system. More preferably, an open and closed system comprising a solid barrier, and more preferably an open and closed valve system. In another embodiment, the solid barrier comprises a solid or semi-solid mass, including, for example, a valve-like structure or flange-like structure, that is at least substantially impermeable to non-ground or ground smokable substances, including but not limited to, plastic, metal, wood, glass, or any other composite or polymer material that is at least substantially impermeable to ground smokable substances. Further, the articulating barrier may also comprise any shape including, but not limited to, crescent-shaped, oblong, rod-like, flange-like, rectangular, slat-like, plank, or solid strip. The articulating barrier may comprise a one-way valve. In another embodiment, when the barrier is in the closed position, the length, shape and/or configuration of said barrier preferably prevents most, if not all, of said smokable substances from leaking from compartment 21 or collection unit 73, respectively.

In another embodiment, the articulating barrier, more preferably an articulating one-way valve, extends at least substantially horizontally relative to the interior wall of compartment 21 or collection unit 73 and come into contact with all sides of each said respective component's interior, where such contact is sufficient to prevent at least substantially all the non-ground ground and ground smokable substance from passing beyond said barrier and entering into grinder 3 and dispensing port, respectively. The articulating barrier may be electronically or manually activated into the “open position” where, for example, said barrier is positioned in such a manner that allows the smokable substance to pass through. In another embodiment, the open position of said barrier may include positioning said barrier at least substantially perpendicular to the interior wall of the storage compartment 21 and collection unit 73, thus allowing the smokable substance to pass through.

In yet another embodiment, said open position may comprise said barrier being in either an upward or downward position. In said open position, the smokable substance may flow through compartment 21 and collection unit 73 whereby said flow may continue through an opening at or near each of said components lower end, at which point, the smokable substance may then flow and accumulate in the grinder and dispensing port, respectively. The non-ground and ground smokable substance may continue to flow out of compartment 21 or collection unit 73 until all the contents therein are released or the desired amount thereof has been released into grinder 3 or dispensing port, respectively, or until the articulating barrier is electronically or manually activated such that the barrier is in the closed position, where the flow of non-ground and ground smokable substance into grinder 3 and dispensing port, respectively, ceases.

In another embodiment, the articulating barrier may be electronically and communicatively coupled to an electronic circuit board or PCB, and power source (e.g. internal rechargeable battery) such that said barrier may be readily moved in the open or closed position via depressing a button on the external surface of the present invention, or by touching the appropriate icon or indicia on the touch display. Activation of said barrier may also be effectuated manually by manipulating a lever which is communicatively coupled to the articulating barrier, thus enabling said barrier to be in either in the open or closed position. Said activation may also be effectuated manually via a barrier comprising a snap hinge, whereby said hinge is attached at or near the lower end of compartment 21 or collection unit 73.

Further, the articulating barrier also comprises a rear end and front end, where said rear end may be movably attached on or adjacent to compartment's 21 lower end or the collection unit's 73 lower end. Movably attached may include, but is not limited to, hingedly, articulately, pivotally, or swervingly attached. Other means for attaching, joining or otherwise linking said articulating barrier to compartment 21 or collection unit 73 may include, but are not limited to, a screw, rivet, clasp, hook, or latch, among other means. Said articulating barrier may also be welded, soldered, glued, or otherwise rigidly affixed to, at or near the lower end of storage compartment 21 or collection unit 21. The articulating barrier may also comprise one or more movably attached flanges disposed at or near the lower ends of said components. In yet another embodiment, the articulating barrier may be communicatively coupled to an electronic control board and power source, thus providing means for opening and closing said barrier via depressing a button, or pushing a switch on the external surface of the present invention, or opening and closing said barrier remotely via an App on a mobile electronic device or handheld remote.

In one embodiment, the amount of smokable substance released from storage compartment 21 and/or collection unit 73 may be controlled based on the weight of the ground or non-ground substance as it is released from said components. Means for such control are disclosed herein. In yet another embodiment, once the amount of said substance reaches the desired weight, then the articulating barrier switches from an open position to the closed position, preventing any further discharge of non-ground or ground substance from compartment 21 and collection unit 73, respectively. At this point, non-ground or ground substance already discharged is then released into the grinder 3 or dispensing port, respectively. The open and closed system can prevent excess or undesired amounts of smokable substances to be ground or released in the dispensing port. In yet another embodiment, compartment 21 and collection unit 73 may release the desired amount of non-ground and ground smokable substances into the grinder 3 and dispensing port until the amount of substance released reaches the predetermined weight, at which point the movable barrier is activated to it closed position. In another embodiment, the non-ground and ground smokable substance can be measured by an electronic sensory scale or other scales known in the art. Said scale can regulate the amount of smokable substance already ground based on the weight of said substance. The scale may also provide the weight of the remaining amount of substance inside compartment 21 or collection unit 73. In another embodiment, the total weight of non-ground and ground smokable substance can be digitally displayed on a touch display or an App on a mobile electronic device. In one embodiment, said display may show the incremental weight increase of the ground smokable substance during the grinding process or until the desired amount of grinding has been obtained.

The area in which the barrier is disposed comprises sufficient room to enable an articulating and electronically controllable barrier, thus allowing convenient means for releasing a specified amount of the non-ground or ground smokable substance through the interior of compartment 21 or collection unit 73 and then out through the opening at the lower end of said components into grinder 3 or dispensing unit, respectively. The smokable substance is released when the articulating barrier is in the open position, and said release is stopped when the barrier is in its closed position.

Preferably, the barrier is hingedly attached to the interior wall of the bottom end of storage compartment 21 and bottom portion of collection unit 73. More preferably, the barrier is a valve-like structure, more preferably a one-way valve to prevent any backflow of undesired non-ground or ground substance into compartment 21 or collection unit 21, respectively, once said smokable substance has been released into grinder 3 or dispensing port, respectively.

In another embodiment, the articulating barrier may be disposed at or about the bottom end of compartment 21 and collection unit 73. Said barrier serves to control the amount of non-ground and ground smokable substances to be released inside grinder 3 or dispensing port, respectively. In yet another embodiment, the compartment 21 or collection unit 73 can release the desired amount of ground or non-ground smokable substance into the grinder or dispensing port, respectively, based on certain metrics, including, but not limited to, weight, volume, or fineness. In one embodiment, the weight of the non-ground or ground smokable substance passing through compartment 21 or collection unit 73 may be measured by an electronic sensory device, which weighs and monitors the amount of smokable substance already ground, and also determines the weight of the remaining amount of ground or non-ground smokable substance to be released based on the amount requested by the user.

In another embodiment, there is a space and/or area between the lower end of the storage compartment 21 and the top portion of grinder 3. In yet another embodiment, there is a space and/or area between the lower end of the collection unit 73 and dispensing port. Said space in either embodiment may comprise means for linking said respective components together via a conduit. Said conduit may comprise a channel, tube, groove, slot, trough, hollow, chute, portal or any other structural passageway suitable for receiving and releasing non-ground or ground smokable substances. The compartment 21, collection unit 73 and conduit each having a top and bottom end, where said bottom end of compartment 21 and collection unit 73 may be each securely fastened or removably fastened to the top end of said conduit, and the bottom end of said conduit is securely fastened or removably fastened to the top portion of grinder 3 or dispensing port. In another embodiment, a portal is disposed on the top portion of grinder 3 or dispensing port, where storage component 20 and collection unit 73 may be securely fastened or removably fastened to said portal, thus linking storage compartment 20 with grinder 3, or likewise linking collection unit 73 with dispensing port. The lower end of said conduit may optionally gradually taper to form a funnel-like configuration with an opening at its lower end, which can further facilitate the flow of ground or non-ground substance from compartment 21 into grinder 3.

### Speakers

Speakers are typically housed in a speaker enclosure, including, for example, a speaker cabinet or housing, which may be a rectangular or square box made of several types of wood, metal or plastic. The enclosure's materials and design play an important role in the quality of the sound. The enclosure should sufficiently rigid and non-resonant as practically as possible. Where high fidelity reproduction of sound is required, multiple loudspeaker transducers are often mounted in the same enclosure, each reproducing a part of the audible frequency range.

In this case the individual speakers are referred to as “drivers” and the entire unit is called a loudspeaker. Drivers made for reproducing high audio frequencies are called tweeters, those for middle frequencies are called mid-range drivers, and those for low frequencies are called woofers. Extremely low frequencies (16 Hz-˜100 Hz) may be reproduced by detached subwoofers. Smaller loudspeakers are found in devices such as radios, portable audio players, mobile phones, and PC computers, among others. Speaker systems of the present invention may be used for music and sound reinforcement, among other uses.

In one embodiment, an apparatus 1 is for processing dry materials, smokable materials, and/or ingestible materials and includes an enclosure 28 defining an interior cavity 31 divided into sections by walls that define interior regions comprising a grinding section 3, a dispensing section 21, and an electronics section 37. A grinder assembly 68 fits within the grinding section and is configured to receive dry materials for grinding. A dispensing section 21 with a drawer receives ground materials from the grinder assembly. An electronic control system fits within the electronics section 37. An insulator layer 39 connected to at least the walls defining the electronics section separates the electronics section from the grinder assembly and the dispensing section.

The grinder assembly may include a motor 14 controlled by the electronic control system.

The grinder assembly may include grinding elements 29 connected to a respective top section and bottom section of the grinder assembly.

The top section 70 and the bottom section 71 of the grinder assembly are configured to join together and define an area for receiving the ground material.

The area for receiving the ground material may be surrounded by portions of the grinder assembly defining a holding container 33 for the ground material.

The grinder assembly may include a screen 43 between the grinding elements and the holding container 33, wherein the screen allows select particles of the ground material to enter the holding container.

The drawer of the dispensing section receives the ground material from the screen.

The insulator layer may include shock absorbing materials to separate vibrational energy from the grinding section from the electronics section.

The insulator layer may include a polymer, a rubber, a nylon, or a plastic.

The electronics section may include a computer storing a control system that operates a motor connected to the grinder assembly.

The electronics section may include a computer storing a control system that operates an entertainment system comprising speakers.

The electronics section may include a power supply connected to the computer and the motor.

The electronics section may include a computer configured to receive electrical inputs from ports built into the enclosure.

The electronic control system and the grinding assembly operate simultaneously while separated from each other by the insulator layer.

The drawer is removable from the dispensing section.

The dry material and the ground material may be a smokable material or an ingestible material as described herein.

A computer within the electronics section is equipped with a processor and computer memory to store software that enables an electronic control system to control motor speed, motor on and off, grinding duration, and multimedia entertainment from accessories implemented in the enclosure, such as music speakers and the like.

These and other aspects of the disclosure are further set forth in the claims and the figures.

1. An apparatus for processing dry materials, comprising:
an enclosure defining an interior cavity divided into sections by walls that define interior regions comprising a grinding section, a dispensing section, and an electronics section;
a grinder assembly that fits within the grinding section and configured to receive dry materials for grinding;
a dispensing section that comprises a drawer receiving ground materials from the grinder assembly;
an electronic control system that fits within the electronics section;
an insulator layer connected to at least the walls defining the electronics section to separate the electronics section from the grinder assembly and the dispensing section.

2. The apparatus of claim 1, wherein the grinder assembly comprises a motor controlled by the electronic control system.

3. The apparatus of claim 2, wherein the grinder assembly comprises grinding elements connected to a respective top section and bottom section of the grinder assembly.

4. The apparatus of claim 3, wherein the top section and the bottom section of the grinder assembly are configured to join together and define an area for receiving the ground material.

5. The apparatus of claim 4, wherein the area is surrounded by portions of the grinder assembly defining a holding container for the ground material.

6. The apparatus of claim 4, wherein the grinder assembly further comprises a screen between the grinding elements and the holding container, wherein the screen allows select particles of the ground material to enter the holding container.

7. The apparatus of claim 6, wherein drawer of the dispensing section receives the ground material from the screen.

8. The apparatus of claim 1, wherein the insulator layer comprises shock absorbing materials to separate vibrational energy from the grinding section from the electronics section.

9. The apparatus of claim 8, wherein the insulator layer comprises a polymer, a rubber, a nylon, or a plastic.

10. The apparatus of claim 1, wherein the electronics section comprises a computer storing a control system that operates a motor connected to the grinder assembly.

11. The apparatus of claim 1, wherein the electronics section comprises a computer storing a control system that operates an entertainment system comprising speakers.

12. The apparatus of claim 10, wherein the electronics section comprises a power supply connected to the computer and the motor.

13. The apparatus of claim 1, wherein the electronics section comprises a computer configured to receive electrical inputs from ports built into the enclosure.

14. The apparatus of claim 1, wherein the electronic control system and the grinding assembly operate simultaneously while separated from each other by the insulator layer.

15. The apparatus of claim 1, wherein the drawer is removable from the dispensing section.
